(19) United States
(12) Patent Application Publication
(10) Pub. No.: US 2016/0008918 A1
(43) Pub. Date: Jan. 14, 2016

(54) CONTROLLED SPEED FRICTION STIR TOOL PROBE BODIES HAVING NON-LINEAR, CONTINUOUS, MONOTONICALLY-DECREASING CURVED AXIAL PROFILES AND INTEGRATED SURFACE FEATURES

(71) Applicant: Dwight A. Burford, Wichita, KS (US)

(72) Inventor: Dwight A. Burford, Wichita, KS (US)

(21) Appl. No.: 14/796,868

(22) Filed: Jul. 10, 2015

Related U.S. Application Data
(60) Provisional application No. 62/023,485, filed on Jul. 11, 2014.

(51) Int. Cl. B23K 20/12

(52) U.S. Cl. CPC B23K 20/1245

(57) ABSTRACT

A friction stir processing tool and method for manufacturing the same are provided. The tool includes a non-consumable, interchangeable friction stir probe body. The tool includes a material flow path defined by an outer surface of a probe body, which has a non-linear, continuous, monotonically-decreasing axial profile. The probe body is adapted to engage a workpiece material to perform a friction stir process by rotating about an axis thereof thereby directing a weld material toward a distal end of the probe body along the flow path. The flow path varies in pitch as the lateral cross-sectional dimension of the probe body decreases toward the distal end thereby causing the weld material to maintain a controlled speed as it travels along the flow path. Geometric surface features such as threads, helical grooves, ridges, flutes, and/or flats, integrated with the probe body may define the flow path.

### CROSS-REFERENCE TO RELATED APPLICATIONS

The present application claims priority to U.S. Provisional Patent Application No. 62/023,485, filed Jul. 11, 2014, which is incorporated herein by reference in its entirety.

### BACKGROUND

1. Field of the Disclosure

Aspects of the present disclosure generally relate to friction stir processing tools adapted to engage a workpiece in a friction stir processing technique, such as friction stir welding (FSW), friction stir spot welding (FSSW), and/or friction stir processing (FSP), and in particular, to friction stir processing tools that provide for a controlled speed of weld material along a material flow path on and along the probe surface.

2. Description of Related Art

Tools and processes for producing continuous butt joints by friction stir welding between two or more workpieces made of “metals, alloys or compound materials such as MMC, or suitable plastic materials such as thermo-plastics” is disclosed by Intl. Pub. No. WO 93/10935, which is incorporated herein in its entirety by reference.

Since the initial introduction of friction stir welding techniques for welding butt joints, as disclosed in Intl. Pub. No. WO 93/10935 A1, which is incorporated herein by reference in its entirety, variants of the basic process have been disclosed that expand its usefulness. For example, European Pat. No. EP 0 752 926, which is incorporated herein in its entirety by reference, discloses the use of friction stir welding as a means of producing a variety of permanent joint configurations aside from the basic butt joint, such as lap joints, corner joints, T-joints, and combined butt and lap joints. Other innovations involve controlling the rotational motion of the probe independent from that of the shoulder. Further, the rotational direction of the shoulder of a tool body may be opposite the rotational direction of the pin as disclosed, for example, in U.S. Pat. No. 7,703,654, which is incorporated herein by reference in its entirety. Alternatively, the shoulder may be stationary in either direction during the process, and in such a case, only the probe body rotates, as disclosed in U.S. Pat. No. 6,811,632, which is incorporated herein by reference in its entirety.

Friction stir spot welding (FSSW) is a further expansion of the usefulness of friction stir welding. FSSW involves forming permanent lap joints with a series of discontinuous joints located along the joint line at discrete locations and/or over discrete intervals. The discrete joints formed by FSSW are also referred to as integral fasteners, as disclosed in U.S. Pat. No. 8,444,040, which is incorporated herein in its entirety by reference, and in a paper by Burford et al., entitled Fatigue Crack Growth in Integrally Stiffened Panels Joined Using Friction Stir Welding and Swept Friction Stir Spot Welding, 5 (no. 4) JOURNAL OF ASTM INTERNATIONAL (2008), which is also incorporated herein in its entirety by reference. The discrete joints may be formed by a plunge, dwell, and retract cycle of the weld tool as disclosed, for example, in U.S. Pat. No. 6,601,751, which is incorporated herein by reference in its entirety. Alternatively, the joints may be formed through a more complex plunge and retract cycle, also referred to as Refill FSSW, as disclosed, for example, in U.S. Pat. No. 6,722,556, which is incorporated herein by reference in its entirety. Discrete joints may also be formed via short (stitch) FSW lap joints as disclosed, for example, in U.S. Pat. No. 6,604,667, which is incorporated herein by reference in its entirety. Further, they may be formed by producing tightly-circumscribed FSW lap joints, which may be circular or non-circular (e.g., oblong) in shape within the plane of the faying surface of a lap joint as disclosed, for example, in a paper by A. C. Addison and A. J. Robelou, entitled Friction Stir Spot Welding: Principle Parameters and Their Effects, in PROCEEDINGS OF THE 5TH INTERNATIONAL FSW SYMPOSIUM, Metz, France (2004), and as described in U.S. Pat. No. 8,444,040, which are incorporated herein by reference in their entireties.

Friction stir processing (FSP) is a non-joining variant of the basic technology utilized in FSW. In FSP, the probe portion of the axially-rotating, non-consumable tool is forced into and selectively translated within the workpiece to locally modify the microstructure and material properties of the workpiece. Example uses include refining the workpiece grain size to enhance toughness and fatigue resistance, as disclosed in U.S. Pat. No. 6,843,404, which is incorporated herein by reference in its entirety, and to enhance superplastic behavior as disclosed, for example, in U.S. Pat. No. 6,712,916, which is incorporated herein by reference in its entirety. FSP is also used to break up as-cast or fusion-welded microstructure as disclosed in U.S. Pat. No. 6,230,957, which is incorporated herein by reference in its entirety, and to eliminate casting porosity through local mechanical stifling and mixing as disclosed in U.S. Pat. No. 7,225,969 and in a book chapter by R. S. Mishra and M. W. Mahoney, entitled Friction Stir Processing, in FRICTION STIR WELDING & PROCESSING, Chapter 14, edited by R. S. Mishra and M. W. Mahoney, ASM International, Materials Park, Ohio (2007), which are incorporated herein by reference in their entireties. Another application of FSP involves selectively modifying the composition or producing metal matrix composites within limited regions of the workpiece(s) by adding materials and/or dispersing reinforcement material or particles using local mechanical stirring and mixing as disclosed, for example, in U.S. Pat. No. 8,220,693, which is incorporated herein by reference in its entirety.

At any given time during FSW, FSSW, and FSP, only a limited volume of workpiece material adjacent to the weld tool is directly affected by the stifling action of the tool. As such, these processes constitute a unique class of localized solid-state (sub-solidus) metal working processes. Notwithstanding the localized nature of these processes, in the immediate region surrounding the friction stir tool, they share some similarities with bulk metalworking processes. As may be experienced in forging and extruding operations, the friction stirred (worked) material experiences high strains at elevated temperatures (above ambient but below the solidus temperature of the workpiece). Yet, because of the localized nature of the process, friction stir processes induce steep thermal gradients in the workpiece(s) that are significantly greater than those typically produced in bulk-forming operations. The thermal gradients are, however, substantially less severe than those produced during other localized welding processes like fusion welding, in which the temperature in the joint region reaches the melting point of the workpiece(s).

Friction stir processes are dynamic in nature, as described by Burford et al. in an article entitled Early Detection of Volumetric Defects Using e-NDE during Friction Stir Welding, PROCEEDINGS OF THE 9TH INTERNATIONAL FRICTION STIR WELDING SYMPOSIUM, The Von Braun Center, Huntsville, Ala. (2012). During conventional friction stir processes, the weld tool is observed to oscillate side-to-side as it is advanced along the joint line or processing path. The rotating tool presses against the material directly ahead of it in the line of travel, creating a shearing action that extends around the tool front. When the material in front of the tool is sufficiently heated under the pressure and shearing action imposed on it by the advancing, rotating FSW tool, “thin layers of material are transported from the advancing side of the tool to the retreating side of the tool. This action is repeated as the material ahead of the tool is again heated and pressed against sufficiently to cause it to shear and be transported along the front of the advancing tool. Each time material is transported across the face of the tool (probe), cooler (and undeformed) material is again exposed to the leading face of the tool. This sequence of events leads to a repeating process of heating and shearing followed by heating and shearing (heat-shear-heat-shear . . . ). The new interface ahead of the tool is again pressed upon until it is sufficiently heated to move the next band of material along the tool front from the advancing side to the retreating side. This undulation in metal movement along the leading edge of the tool promotes an oscillatory or alternating pattern in both normal and shear forces acting on the tool surface, which in turn causes the tool to move in a periodic or oscillatory motion, nominally side-to-side, as the tool is advanced.”

It is further stated by Burford et al. that “ . . . chaotic oscillations in FSW tend to be associated with the formation of volumetric defects (voids) within the joint, resulting from the lack of consistency in the reconsolidation of material along the joint line.” The oscillating motion or pattern of the advancing, rotating tool is affected by the amount of energy that is transferred into the workpiece material immediately around the rotating-traversing tool. When the level of energy or heat input is increased, the extent of material softening ahead of the tool correspondingly increases, which in turn tends to dampen the amplitude of side-to-side oscillations of the tool. This result may be achieved by increasing the tool rotational speed while maintaining a constant tool travel rate or by lowering the tool travel rate while maintaining a constant tool rotational speed. It may also be altered by changing the tool probe profile and/or surface features.

As a result of this periodic nature of friction stir processes, the tool, especially the probe, experiences rotating, bending fatigue at elevated temperatures. Strong oscillating traverse forces acting on the traversing tool, including chaotic oscillations, may be expected to reduce tool life through a complex process of fatigue in proportion to the frequency of the oscillations as well as the magnitude (amplitude) of the forces. The amount of oscillatory loading a given tool is able to sustain over time is dependent upon design as well as tool materials. Tools with inefficient designs, that require a substantial force to move the tool through the workpiece, must be driven at lower rates than tools with more efficient designs. For example, tools with frustum-shaped probes require less traversing forces than cylindrically-shaped probes having the same base diameter. Therefore, frustum-shaped tools can typically be traversed at a higher rate than cylindrically-shaped tools.

In their paper, Burford et al. examined the emergence of continuous voids in the presence of joint gaps of different shapes and sizes. It was observed that, in general, continuous voids tended to first form on the lower portion of the advancing side of FSW joints. Although only one tool was discussed in the paper by Burford et al., other research has shown that tool geometry influences defect formation, with continuous internal voids typically forming on the advancing side. For example, in Friction Stir Tooling: Tool Materials and Designs, in FRICTION STIR WELDING AND PROCESSING, Chapter 2, edited by R. S. Mishra and M. W. Mahoney, ASM International, Materials Park, Ohio (2007), Fuller discussed different imperfections that may occur during friction stir welding and which are deleterious to joint properties. These included advancing side continuous voids, joint line remnant flaws, and incomplete root penetration, also known as a lack of penetration (LOP) flaw. Of specific interest here is the research Fuller cited relating tool design to the formation of these imperfections. For example, void formation may form on the advancing side of the joint due to insufficient forging pressure as well as too high of welding speed for the given tool design. A joint line remnant may result depending upon tool-related factors, including poor positioning of the weld tool relative to the joint line, too fast of a travel speed, or too large of a tool shoulder for the given tool design. Also, a LOP flaw may occur when the tip of the probe does not extend sufficiently through the thickness of the workpiece. The strength of the joint is compromised as a result due to the incomplete consolidation of joint material through the thickness of the part.

More information regarding FSW and the related processes of FSSW and FSP may be found in R. S. Mishra et al., Friction Stir Welding and Processing, 50 MATERIALS SCIENCE AND ENGINEERING R 1-78 (2005); R. S. Mishra et al. (eds.), FRICTION STIR WELDING AND PROCESSING, ASM International, Materials Park, Ohio (2007), and D. Lohwasser and Z. Chen (eds.), FRICTION STIR WELDING: FROM BASICS TO APPLICATION, Woodland Publishing Limited and CRC Press (2010), the contents of which are incorporated by reference in their entireties. Information regarding the conventional joining of different aluminum structural alloys, in particular by friction stir welding, may be found in P. L. Threadgill et al., Friction Stir Welding of Aluminium Alloys, 54 (no. 2) INTERNATIONAL MATERIALS REVIEWS (2009), the content of which is incorporated by reference in its entirety.

Additional opportunities exist for improving the design of probe bodies for friction stir processes. For example, an abrupt change in the cylindrically-shaped probe is located at the corner between the side of the cylinder and its domed end. At this location, an angle is formed between the normal forces acting on the cylinder profile and those acting on the domed end. For a frustoconically-shaped probe, one may observe, for example, that its tapered shape introduces a vertical component to the traversing force which holds potential for promoting material movement toward the distal end of the probe. Specifically, it introduces a component of the normal force distribution established on the profile of the traversing probe, which is directed along the axis of the probe. It may further be observed that an abrupt change in normal forces acting in the central plane of the joint occurs near the distal end of the probe profile. For the frustum shape, the direct normal forces acting on the profile of the probe become nonexistent past the distal end. With this abrupt change in the probe profile at the distal end of a truncated tool, care must be taken in practice to ensure that the distal end of the probe is maintained sufficiently close to the supporting anvil to produce adequate stirring of the workpiece material under the tool. Otherwise the LOP flaw, which weakens the joint, is typically observed to form in the joint region nearest the supporting anvil. A method of constructing probes that eliminates or at least reduces this abrupt change in force orientation and distribution at the distal end of probes holds a potential for eliminating or at least reducing the associated flaws and, thereby, for reducing the sensitivity of friction stir processes to the formation of the LOP flaw.

A frustum-shaped probe may be observed to introduce another notable effect in friction stir processes. The surface speed of a probe rotating about its axis decreases substantially in correspondence with the decrease in diameter of the probe from its proximal end toward its distal end. That is, as workpiece material moves along a thread ridge during friction stir processing—from the exposed end of the probe body's proximal end to its distal end—the speed of the material decreases at a rate that is dependent upon the probe taper angle. The material speed slows at a greater rate as the taper angle is increased. Therefore, an opportunity exists to improve the performance of friction stir tool probes by providing improved probe bodies having surface features that address limitations or inadequacies found in conventional friction stir processing tool designs.

### BRIEF SUMMARY OF THE DISCLOSURE

The above and other needs are met by aspects of the present disclosure which, in one aspect, provides a friction stir processing tool comprising a material flow path defined by a distal end of an outer surface of a probe body. The distal end of the probe body is adapted to engage a workpiece material to perform a friction stir process, and the probe body is rotatable about an axis thereof so as to generally direct a weld material along the material flow path toward the distal end. The material flow path is configured to vary (e.g., decrease) in pitch as the lateral cross-sectional dimension of the probe body decreases toward the distal end so as to maintain a controlled (e.g., constant) speed of the weld material directed along the material flow path toward the distal end.

A method of manufacturing a friction stir processing tool is also provided and includes forming a material flow path defined by a distal end of an outer surface of a probe body. The distal end of the probe body is adapted to engage a workpiece material to perform a friction stir process. The probe body is configured to rotate about an axis thereof so as to generally direct a weld material along the material flow path and toward the distal end. The material flow path is configured to vary (e.g., decrease) in pitch as the lateral cross-sectional dimension of the probe body decreases toward the distal end so as to maintain a controlled (e.g., constant) speed of the weld material directed along the material flow path toward the distal end.

These and other features, aspects, and advantages of the disclosure will be apparent from a reading of the following detailed description together with the accompanying drawings, which are briefly described below.

### BRIEF DESCRIPTION OF THE DRAWINGS

Having thus described the disclosure in the foregoing general terms, reference will now be made to the accompanying drawings, which are not necessarily drawn to scale, and wherein:

FIG. 1A illustrates a perspective view of a two-piece friction stir processing tool according to one aspect of the present disclosure;

FIG. 1B illustrates a sectioned view of the perspective view of the two-piece friction stir processing tool in FIG. 1A, according to one aspect of the present disclosure;

FIG. 1C illustrates a perspective view of a one-piece friction stir processing tool according to one aspect of the present disclosure;

FIG. 2 illustrates a friction stir processing tool engaging a workpiece according to one aspect of the present disclosure;

FIG. 3 illustrates a side view of a probe body of a friction stir processing tool according to one aspect of the present disclosure;

FIG. 4 illustrates a side view comparing a portion of a probe body having an axial profile defined by a non-linear, continuous, monotonically-decreasing function to a portion of a probe body having a frustoconically-shaped axial profile according to one aspect of the present disclosure;

FIG. 5A illustrates schematics of idealized normal force distributions in the central plane of a butt joint for a probe body of a friction stir processing tool having a truncated parabolic shape according to one aspect of the present disclosure;

FIG. 5B illustrates schematics of idealized normal force distributions in the central plane of a butt joint for a probe body of a friction stir processing tool having a truncated elliptical shape according to one aspect of the present disclosure;

FIGS. 5C and 5D illustrate schematics of idealized normal force distributions in the central plane of a butt joint for a probe body of a friction stir processing tool having a truncated parabolic shape wherein the centerline of the parabola is offset from the centerline of the friction stir processing tool according to various aspects of the present disclosure;

FIG. 6 illustrates the normalized speed of a weld material particle traveling along a material flow path for different frustoconically-shaped probe bodies having different included angles according to one aspect of the present disclosure;

FIGS. 7A and 7B illustrate the cosine components of space curves for a cylindrically-shaped probe body according to various aspects of the present disclosure;

FIGS. 8A and 8B illustrate the cosine components of space curves for a frustoconically-shaped probe body in comparison to the space curve for a cylindrically-shaped probe body according to various aspects of the present disclosure;

FIG. 9 illustrates the cosine components of a helical space curve that is configured to direct a weld material particle at a controlled (e.g., constant) speed along the helical space curve flow path toward the distal end of the probe body according to one aspect of the present disclosure;

FIG. 10A illustrates an exemplary probe body having an outer surface that defines a material flow path, which further includes geometric surface features such as a screw thread with a varying helical angle whereby the crest width of the threads are substantially constant along the length of probe body according to one aspect of the present disclosure;

FIG. 10B illustrates a graphical comparison of the normalized speed along various helical flow paths according to one aspect of the present disclosure;

FIG. 11A illustrates a probe body for a friction stir processing tool that includes an axial profile portion based on an ellipse and a first set of material flow paths defined by screw threads and a second set of material flow paths defined by straight flats according to one aspect of the present disclosure;

FIG. 11B illustrates a probe body for a friction stir processing tool that includes an axial profile portion based on an ellipse and a first set of material flow paths defined by screw threads and a second set of material flow paths defined by helical flats according to one aspect of the present disclosure;

FIG. 12 illustrates the size range for an exposed end of individual probe bodies according to one aspect of the present disclosure;

FIG. 13 illustrates a plurality of probe bodies, each probe body having an axial profile based on an offset parabola and having differing number of material flow path(s) defined by a modified ball screw thread according to various aspects of the present disclosure;

FIG. 14 illustrates an axial profile portion of a probe body of a friction stir processing tool having an axial profile based in part on an ellipse having a major axis offset from a centerline of the probe body according to one aspect of the present disclosure;

FIG. 15 illustrates a probe body for a friction stir processing tool at various intervals during a manufacturing process with optional shank clamping features according to various aspects of the present disclosure;

FIG. 16 illustrates a probe body for a friction stir processing tool having an axial profile portion based on an offset elliptical shape and having one or more helical features to provide multiple material flow paths that include a modified helical ball screw thread according to various aspects of the present disclosure;

FIG. 17A illustrates the correlation between the normalized speed at which a weld material particle traverses along a single material flow path for probe bodies having a varying number of flow paths according to one aspect of the present disclosure;

FIG. 17B illustrates the correlation between the cumulative normalized speed at which a weld material particle travels along the material flow path(s) for probe bodies having a varying number of flow paths according to one aspect of the present disclosure;

FIG. 18 illustrates a set of probe bodies for friction stir processing tools that include axial profile portions based on smooth polynomial functions (splines) according to various aspects of the present disclosure;

FIG. 19 illustrates a probe body for a friction stir processing tool configured to direct a weld material at a controlled (e.g., constant) speed along a material flow path that has a decreasing depth from a proximal end to a distal end of the probe body according to one aspect of the present disclosure;

FIG. 20 illustrates a friction stir probe having an elliptical profile and a set of five helical ridges with associated helical flats that are defined by constant speed helical space curves; and

FIG. 21 illustrates a schematic block diagram for a method of manufacturing a friction stir processing tool according to one aspect of the present disclosure.

### DETAILED DESCRIPTION OF THE DISCLOSURE

The present disclosure will now be described more fully hereinafter with reference to exemplary aspects thereof. These exemplary aspects are described so that this disclosure will be thorough and complete, and will fully convey the scope of the disclosure to those skilled in the art. Indeed, the disclosure may be expressed in many different forms and should not be construed as limited to the aspects set forth herein; rather, these aspects are provided so that this disclosure will satisfy applicable legal requirements. As used in the specification, and in the appended claims, the singular forms “a”, “an”, “the”, include plural referents unless the context clearly dictates otherwise.

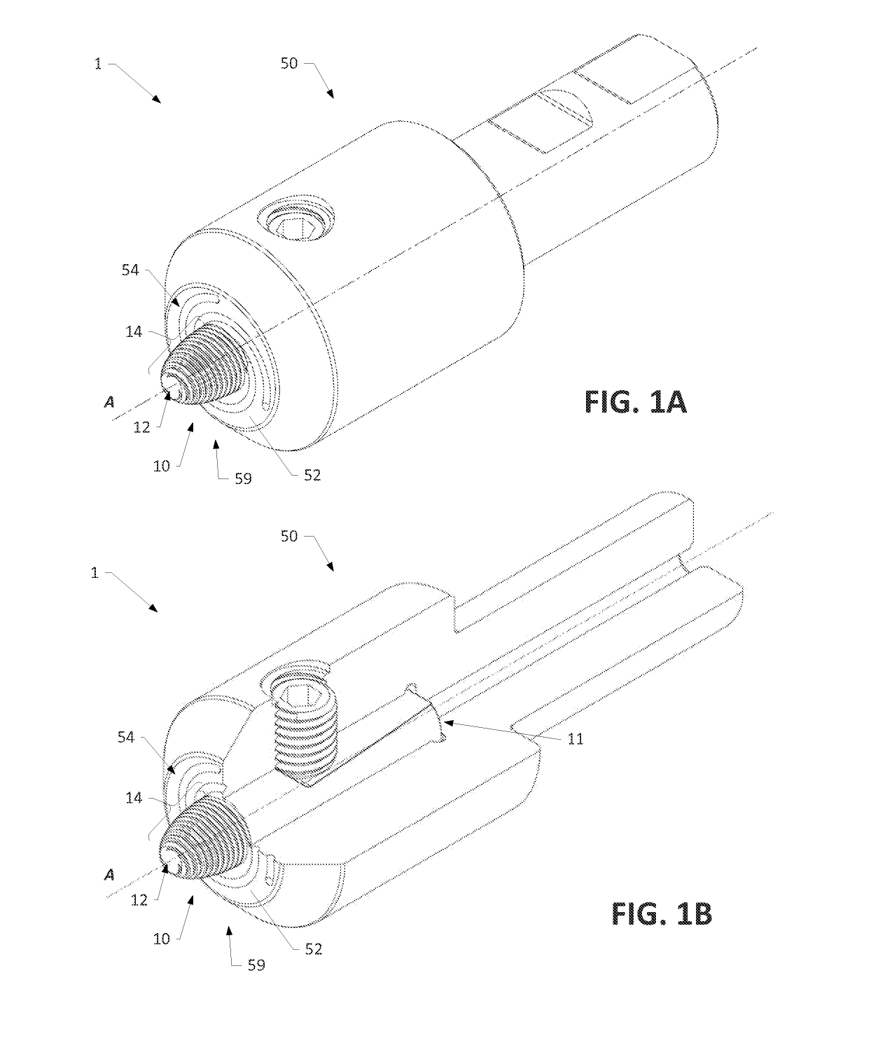

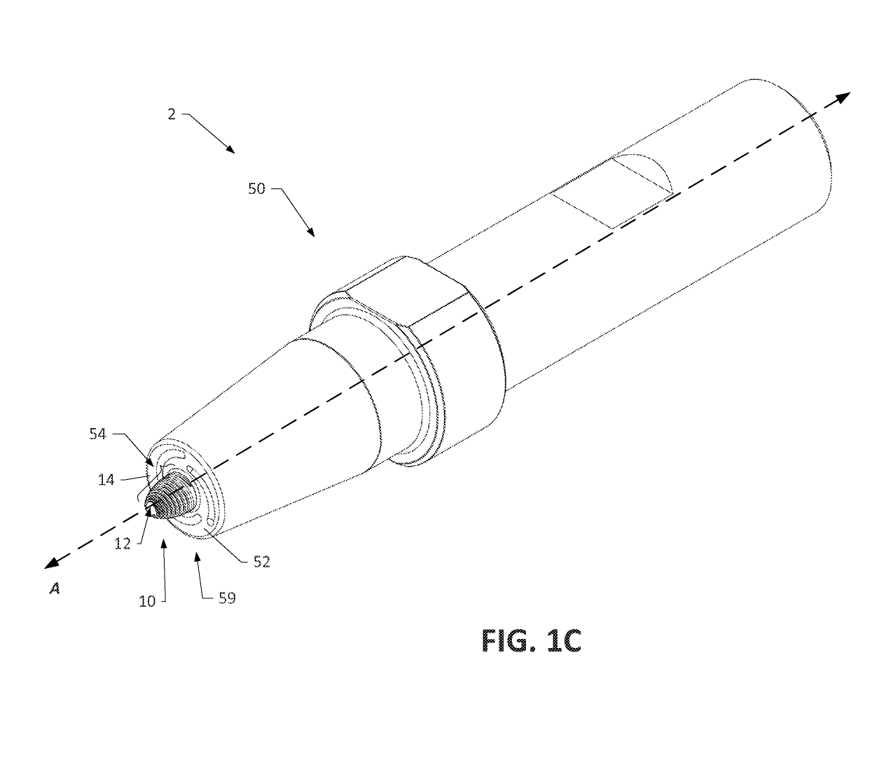

Various aspects of the present disclosure generally relate to a friction stir processing tool configured to be used in friction stir welding (FSW), friction stir spot welding (FSSW), and/or friction stir processing (FSP) of malleable materials, such as non-ferrous metals and related alloys. FIGS. 1A and 1B illustrate a two-piece friction stir processing tool 1, according to one aspect of the present disclosure. Aspects of the present disclosure will be primarily described with reference to this design, but it should be understood that various of these aspects may equally apply to a one-piece design such as that of the one-piece friction stir processing tool 2 shown in FIG. 1C, according to one aspect of the present disclosure.

As shown in FIGS. 1A and 1B, the friction stir processing tool 1 may include a probe body 10 and a tool body 50 that both extend along a longitudinal axis A. The probe body 10 includes a proximal end 11 (shown in FIG. 1B) and a distal end 12. The proximal end 11 of the probe body 10 may be configured to operably engage a distal end 59 of a single-shouldered tool body 50.

The proximal end 11 of the probe body 10 may be configured to operably engage the distal end 59 of the tool body 50. In some aspects, the tool body 50 may define a shoulder contact surface 52 (or simply a “shoulder”) that extends radially outward from the longitudinal axis A and is disposed proximate the distal end 59 of the tool body. In some aspects, the shoulder 52 may extend along a horizontal plane that is disposed orthogonally to the longitudinal axis A. As shown, the shoulder 52 is flat, although it should be understood that the shoulder may have any of a number of different surface profiles, another example of which may be a concave, conically-shaped shoulder. Additionally, the shoulder 52 may be featureless, or in some examples, the shoulder 52 may define any of a number of different scroll patterns. As shown, one example of a suitable scroll pattern is a plurality of spiral-shaped grooves. Exemplary tool bodies having a shoulder defining a scroll pattern are discussed in greater detail in U.S. Pat. Nos. 8,016,179 and 8,579,180 to Burford, both of which are incorporated herein by reference in their entireties.

FIG. 1C illustrates the similar one-piece friction stir processing tool 2 including a probe body 10 and a tool body 50 that both extend along a longitudinal axis A. As shown, for example, the tool body 50 may define a shoulder 52 that extends radially outwards from the longitudinal axis A and is disposed proximate the distal end 59 of the tool body. The shoulder 52 may also define a scroll pattern, which may include a plurality of spiral-shaped grooves 54. Other aspects of the one-piece friction stir processing tool 2 may likewise be similar to the two-piece friction stir processing tool 1, a number of which, although not separately called out, are shown in FIG. 1C.

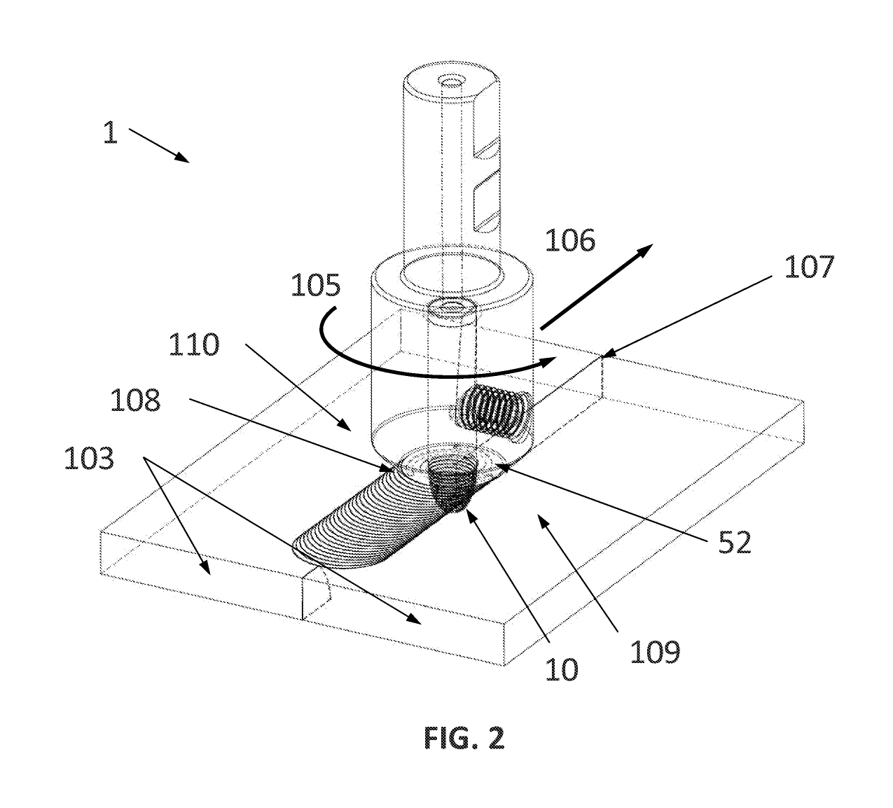

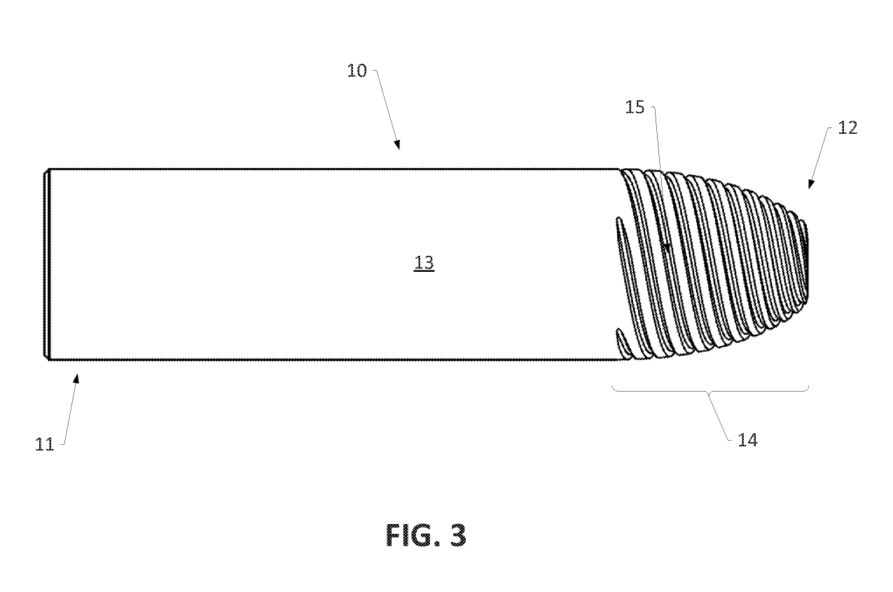

FIG. 2 illustrates a friction stir processing tool 1 generally operating in accordance with one aspect of the present disclosure. In particular, the shoulder 52 of the tool body 50 may rest on an upper surface of a workpiece 103, while the probe body 10 operably engages and/or is embedded in the solid workpiece(s) during a friction stir process such as a friction stir welding process. The probe body 10 of the friction stir processing tool 1 may be configured to rotate about a longitudinal axis thereof along the direction 105. Additionally, the probe body 10 may be configured to be driven transversely in a direction 106 as the probe body rotates about the longitudinal axis thereof. In some aspects, the transverse direction 106 along which the friction stir processing tool 1 is driven may be parallel to a joint line 107, which may be defined by an abutting interface between the workpiece(s) 103. According to one aspect, the friction stir processing tool 1 may be configured to provide frictional heating and/or mechanical stirring of a consolidated joint region 108 (otherwise known as a “stir zone”) due to the rotation of the friction stir processing tool about the longitudinal axis thereof. In this regard, the rotating, non-consumable friction stir processing tool 1 with probe body 10 may provide for the formation of a solid-state joint. In some aspects, the friction stir processing tool 1 may be driven transversely to the tool axis while the shoulder 52 of the tool body 50 concurrently engages the surface of the workpiece(s) 103. For example, the shoulder 52 of the tool body 50 may operably engage, travel along, and/or apply a pressure force to the surface of the workpiece 103 as the friction stir processing tool 1 is driven transverse to the tool axis and along the joint line 107 and/or along a direction parallel to the joint line. In particular, the shoulder 52 may provide frictional heating and/or mechanical containment of workpiece material within the stir zone 108 (also referred to herein as “weld material”). The probe body 10 may provide for subsurface stirring within the workpiece material to form a consolidated stir zone 108 that extends throughout the thickness of the workpiece 103. Additionally, a first side with respect to the joint line 107, from which the friction stir processing tool 1 rotates, may be referred to as the advancing side 109. Likewise, an opposing second side with respect to the joint line 107, toward which the friction stir processing tool 1 rotates, may be referred to as the retreating side 110.

In this regard, during a friction stir process, the rotating friction stir processing tool 1 may directly affect a limited portion of the workpiece material, and in particular, a limited portion of the workpiece material disposed proximate to the probe body 10 and/or tool body 50 of the friction stir processing tool. In particular, some friction stir processes according to aspects of the present disclosure constitute a unique class of localized solid-state (sub-solidus) metal-working processes. Notwithstanding the localized nature of these processes, in the immediate region surrounding the friction stir processing tool 1, these localized solid-state metal working processes share some similarities with bulk metalworking processes. As may be experienced in forging and extruding operations, a material exposed to a friction stir process may experience high strains at elevated temperatures (above ambient but below the solidus temperature of the workpiece). Yet, because of the localized nature of the process, friction stir processes induce steep strain and thermal gradients in the workpiece(s) 103 that are significantly greater than those typically produced in bulk metalworking processes. The thermal gradients induced by friction stir processes are, however, substantially less severe and/or steep than those thermal gradients that are produced by other localized welding processes, such as fusion welding where the temperature in the joint region reaches the melting point of the workpiece material.

Additionally and/or alternatively, during one friction stir process according to some aspects of the present disclosure, the friction stir processing tool 1 may press against the workpiece 103 proximate a location where an axial profile portion 14 of the probe body 10 (the exposed portion of the probe body 10 that extends outward from the shoulder 52) and the workpiece interact, and more particularly, proximate the transverse direction of travel 106 ahead of the location where the axial profile portion 14 and the workpiece interact. In this regard, the probe body 10 is configured to impart a shearing force that extends around the front of the axial profile portion 14. When the workpiece material in front of the axial profile portion 14 and under the tool body shoulder 52 is sufficiently heated under the pressure and the shearing action imposed on it by the transversely advancing and rotating friction stir processing tool 1, thin layers of the workpiece material are transported from the advancing side 109 to the retreating side 110. This action is repeated as the workpiece material ahead of the friction stir processing tool 1 is again heated and pressed against sufficiently to cause it to shear and be transported along the front of the transversely advancing friction stir processing tool. Each time material is transported across the face of the axial profile portion 14, cooler (and undeformed) material is again exposed to the leading face of the probe body. This sequence leads to a repetitive process of heating and shearing, and the workpiece material (also referred to herein as “weld material”) transported across the face of the axial profile portion 14 may also form the consolidated joint region and/or stir zone 108 in the wake of the rotating, traversing weld tool.

FIG. 3 illustrates a probe body 10 including its axial profile portion 14 as part of an outer surface 13 that extends from the proximal end 11 to the distal end 12 of the probe body. Additionally, at least one material flow path 15 may be defined by the axial profile portion 14 at the distal end of the outer surface 13 of the probe body 10. In some aspects, at least one material flow path 15 traverses about the axial profile portion 14 of the probe body 10 along a substantially helical path. That is, at least one material flow path 15 may extend helically about the axial profile portion 14 of the probe body 10. Additionally and/or alternatively, the material flow path 15 may be configured to direct a weld material along the material flow path toward the distal end 12 of the probe body 10 in accordance with a controlled speed function when the probe body rotates about an axis thereof. For example, in some aspects, the material flow path 15 may be configured to direct a weld material along the material flow path toward the distal end 12 of the probe body 10 such that the weld material maintains a controlled (e.g., constant) speed as it is directed along the material flow path toward the distal end. According to some aspects, the material flow path 15 may include threads, flats, flutes, grooves, and/or the like, or any combination thereof.

In some aspects, an axial profile portion 14 of the probe body 10 disposed proximate the distal end 12 may be shaped in accordance with a continuous, monotonically-decreasing function. According to another aspect, the axial profile portion 14 may be shaped in accordance with a non-linear, continuous, monotonically-decreasing function. For example, various exemplary axial profile portions 14 may be shaped in accordance with geometric functions, such as parabolas, ellipses, hyperbolas, and/or other mathematical functions including smooth polynomial functions (otherwise known as spline functions) that are continuous and monotonically decreasing. In some aspects, the lateral cross-sectional dimension of the probe body 10 within an interval defined by the axial profile portion 14 decreases toward the distal end 12.

For a multiple-piece tool design, where the probe body 10 is not integral to the tool body 50, the probe body 10 of the friction stir processing tool 1 may form a shank that fits into the tool body 50, allowing the working end of the probe body 10 (axial profile portion 14) to be rigidly held in place ready for use. The shank may be straight, but it can include a tapered section (either way) to help center it and hold it at the right position along the longitudinal axis A of the friction stir processing tool 1. It should therefore be understood that in some but not all examples the probe body may include a shank, which may but need not be straight.

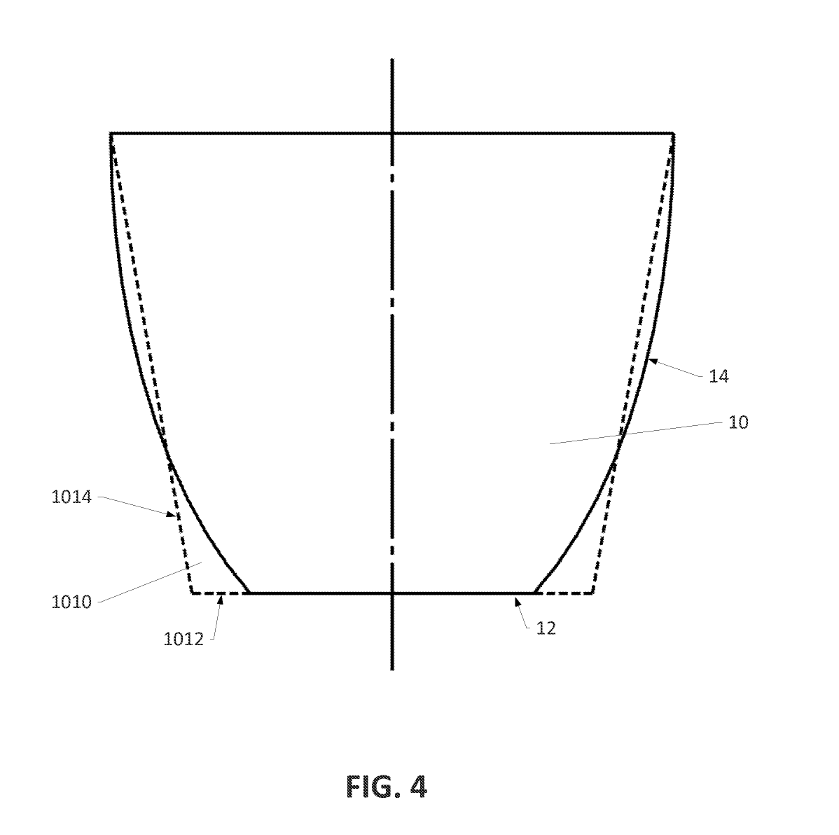

Turning now more specifically to the working end of the probe body 10, the axial profile portion 14 in some aspects may advantageously provide a reduced transition angle between a curved segment of the axial profile portion and a truncated tip defined by the distal end 12 of the probe body 10 compared to the transition angle between a substantially linear segment of a traditional axial profile portion 1014 and a truncated tip defined by the distal end 1012 of a truncated frustoconically-shaped probe body 1010, as illustrated in FIG. 4. For example, FIG. 4 particularly illustrates a comparison between the axial profile area of a frustoconically-shaped probe body 1010 having a 10° taper and the axial profile area of an elliptically-shaped probe body 10. Both the elliptically-shaped probe body 10 and the frustoconically-shaped probe body 1010 have the substantially equal profile areas of 42.10 mm², base diameters of 7.75 mm, and lengths of 6.35 mm. The axial profile of the elliptically-shaped probe body 10, which is based on a semi-ellipse, provides a greater amount of tool material proximate the proximal end of the tool body compared to the frustoconically-shaped probe body 1010, which places more tool material located at its distal end. Accordingly, aspects of the present disclosure may advantageously provide a friction stir processing tool that has increased tool life and resistance to failure by fracture and/or fatigue.

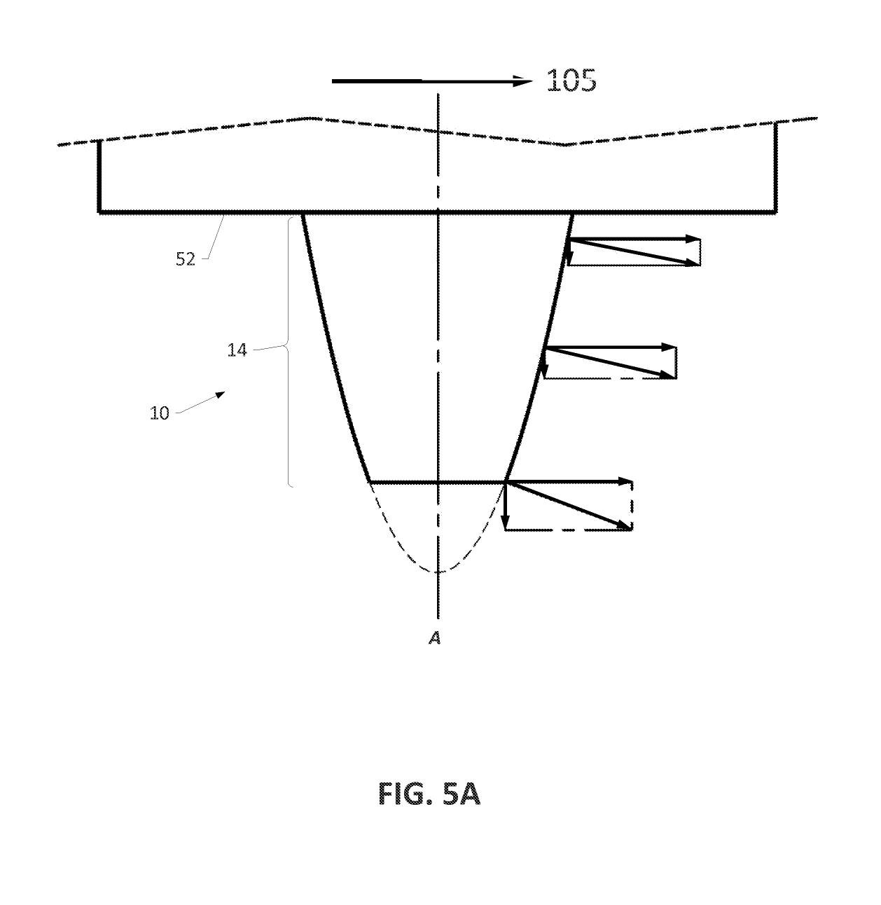

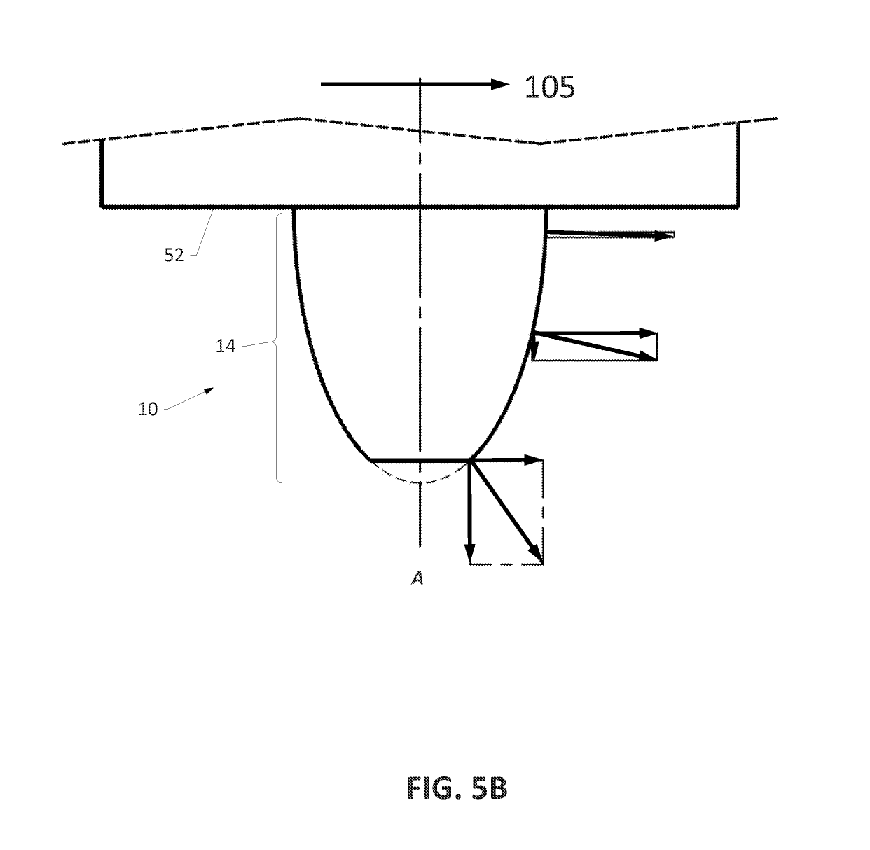

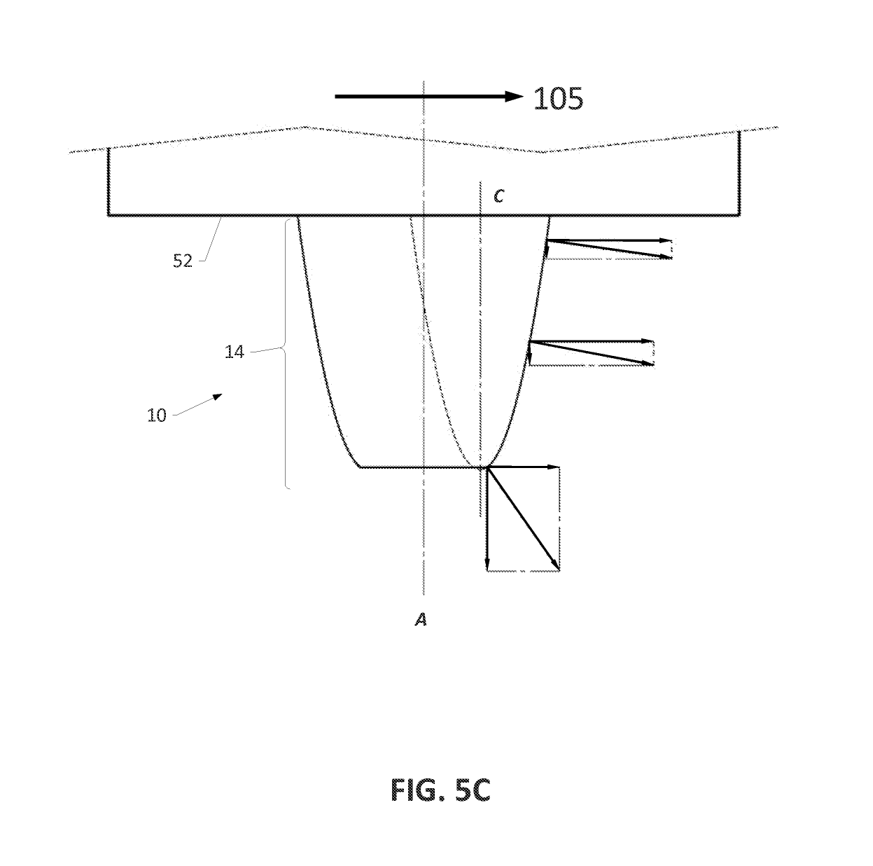

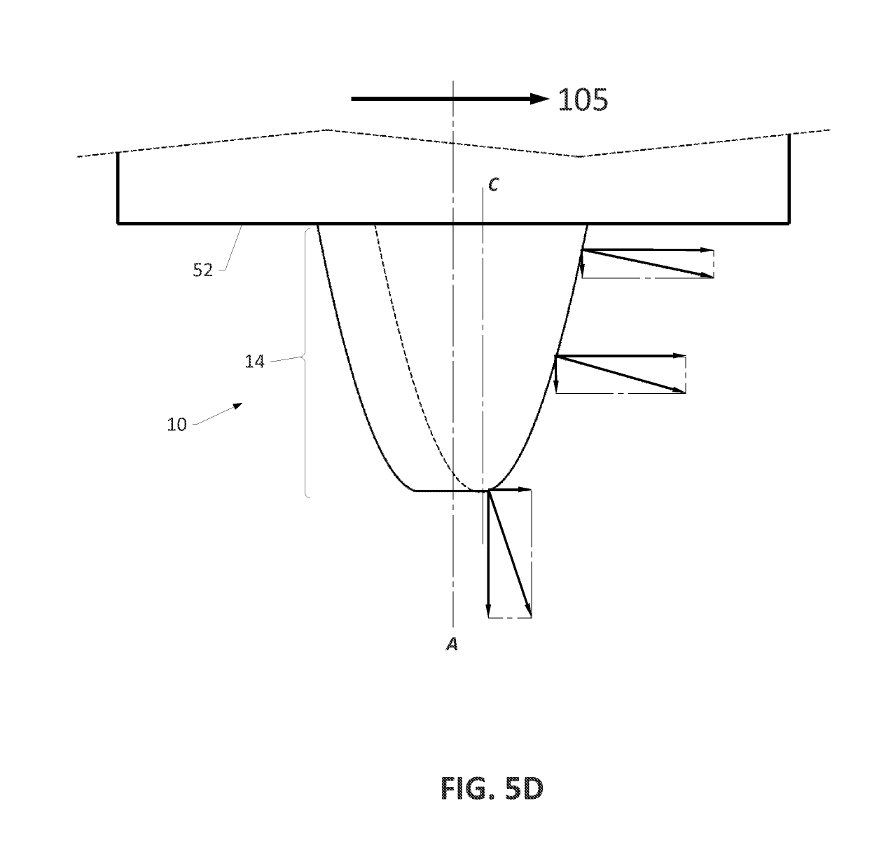

FIGS. 5A-5D illustrate a schematic of idealized normal force distributions in the central plane of a butt joint for various probe bodies of a friction stir processing tool that include a curved axial profile portion 14 having a shape defined by a non-linear, continuous, monotonically-decreasing function in accordance to various aspects of the present disclosure. In particular, FIG. 5A illustrates a schematic of an axial profile for a probe body 10 where the shape of the curved axial profile portion 14 is based upon a portion of a truncated parabola. FIG. 5B illustrates a schematic of a curved axial profile for a probe body 10 where the shape of the curved axial profile portion 14 is based upon a portion of a truncated ellipse. Although FIGS. 5A and 5B illustrate the curved axial profile portion(s) 14 being truncated, one of ordinary skill in the art may appreciate that the axial profile portion(s) may be preserved to provide a substantially smooth transition from the side of the profile to the distal tip of the probe body 10. Generally, the curved axial profile portions of the probe bodies in accordance with various aspects of the present disclosure may be defined as having a smaller diameter at the distal ends of the probe bodies compared to the diameter at their respective proximal ends connected with a smooth, monotonically-decreasing transition from the proximal to the distal ends.

Some aspects of the present disclosure advantageously provide for curved axial profile portions for probe bodies 10 that provide more desirable normal force distributions along the length of the curved axial profile portion 14 of the probe body. For example, as shown in FIGS. 5A-5D, the non-linear, continuous, monotonically-decreasing axial profiles of the probe bodies provide for a greater vertical component of the normal component of the traversing forces acting in the central plane of a friction stir welding joint when measured proximate the distal end compared to the vertical component of the normal component of the traversing forces acting in the central plane of a friction stir welding joint when measured proximate the proximal end. Accordingly, aspects of the present disclosure may advantageously provide a probe body configured to increase the direction of material flow (i.e., weld material) downwardly beyond the end of the friction stir processing tool as the tool traverses the workpiece. Further, the curved profile of an exemplary probe body is configured to urge weld material movement at a steeper downward trajectory as the weld material approaches the distal end of the probe body, which advantageously promotes better stifling of material proximate and/or below the distal end of the probe body. In this regard, the curved axial profile portion 14 of the probe body 10 promotes greater consolidation of workpiece material in the stir zone on the advancing side of the tool (by increasing the local vertical force) to minimize the formation of advancing side voids near the distal end of the probe. Additionally and/or alternatively, increasing the direction of weld material flowing downwardly beyond the distal end of the friction stir processing tool may advantageously concentrate and/or compact the workpiece material and/or the flow of weld material such that the frequency of lack of penetration (LOP) flaws and/or voids are reduced.

FIGS. 5C and 5D illustrate aspects of the present disclosure that provide an axial profile portion that is shaped based on a parabola having an offset centerline C. In particular, FIG. 5C illustrates a probe body including a curved axial profile portion 14 that is shaped based on a parabola having a centerline C that is offset from the longitudinal axis A of the probe body, while FIG. 5D illustrates a probe body including a curved axial profile portion 14 that is shaped based on a parabola having a centerline C that is offset from the longitudinal axis A of the probe body and a reduced height. In this regard, a probe body 10 having a curved axial profile portion 14 that is shaped based on a parabola having an offset centerline C provides for greater flexibility in controlling the shape of the axial profile portion and/or in designing and/or determining the disposition of at least one material flow path that transverses the outer surface of the probe body.

As previously mentioned, aspects of the present disclosure may provide a friction stir processing tool that includes a material flow path defined by a distal end of an outer surface of a probe body, which has a curved axial profile defined by a non-linear, continuous, monotonically-decreasing function. Such curved axial profiles (e.g., semi-elliptical, parabolic, etc.), however, may complicate the speed of weld material flowing along the material flow path, which in some aspects, may be defined by surface features of the probe body, such as threads, grooves, ridges, flats, and/or the like.

Returning to FIG. 3, according to some aspects, the material flow path 15 may incorporate helical features configured to promote movement and/or flow of a weld material along the material flow path. In some aspects, the material flow path extending about the outer surface of the probe body in a helical manner may be oriented either as a right-hand helix or a left-hand helix such that the material flow path directs a weld material toward the distal end of the probe body as the probe body rotates counterclockwise or clockwise, respectively.

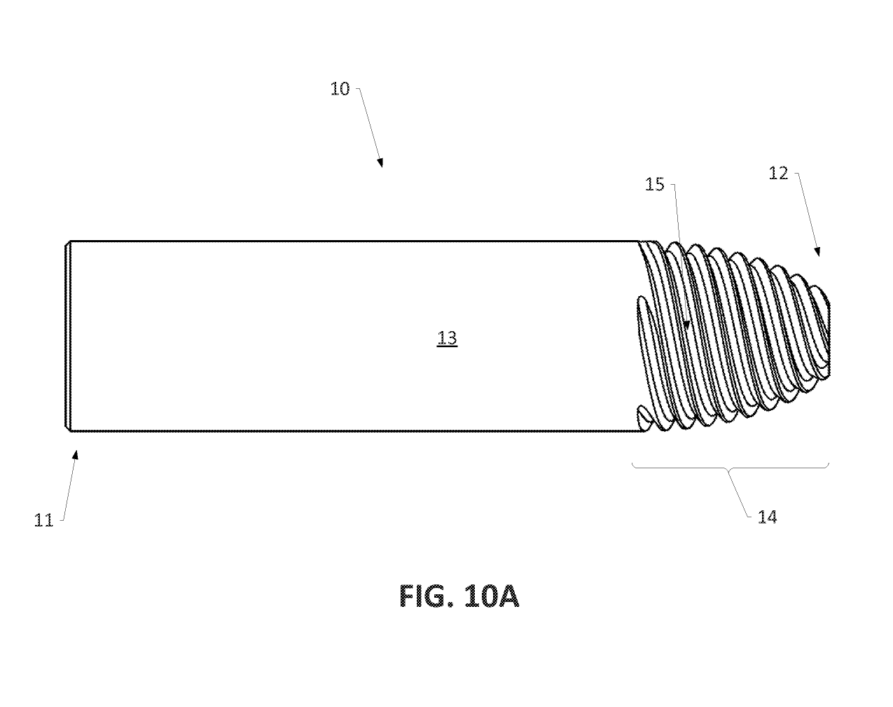

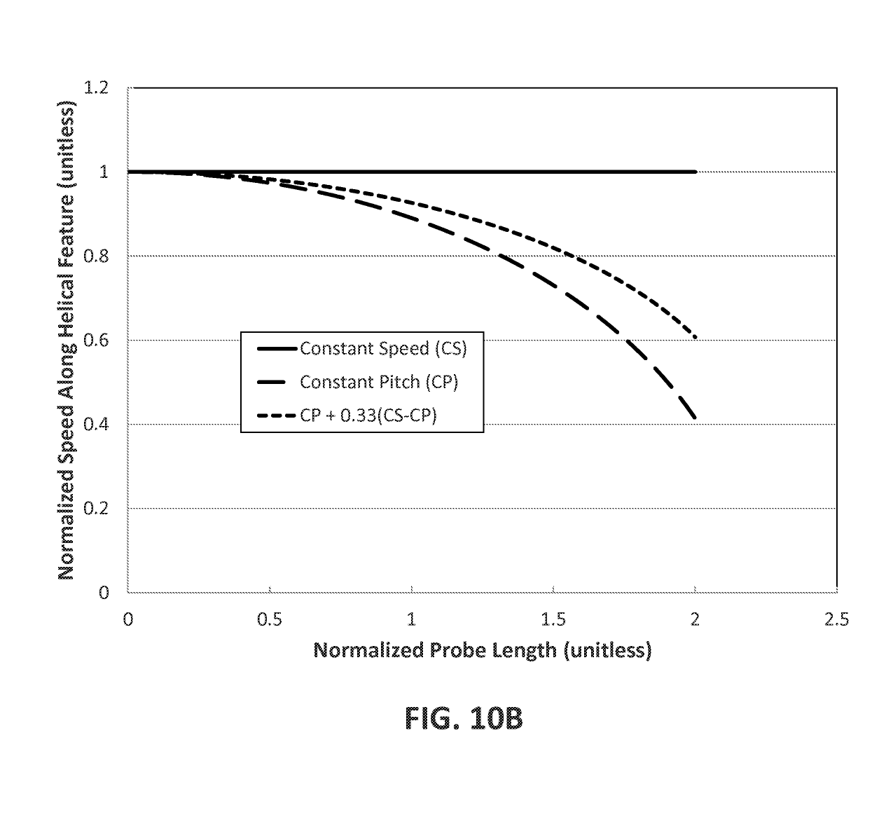

The efficiency of workpiece material and/or weld material movement along a helically-shaped material flow path may depend in part on the geometric shape of the probe body and the helical shape of the material flow path. In some aspects, movement of a weld material may also depend in part upon the coefficient of friction between the outer surface of the probe body and the workpiece material. Additionally, the movement of the weld material along the helically-shaped flow path may depend in part upon the shear strength of the workpiece material disposed proximate to the probe, which may be influenced by temperature and strain rate. Frustoconically-shaped probe bodies having a material flow path, as known to those of ordinary skill in the art, are configured to direct weld material along the material flow path at a decelerating rate as the weld material travels along the material flow path toward the distal end. Various aspects of the present disclosure advantageously provide a friction stir processing tool having a probe body that defines an axial profile defined by a non-linear, continuous, monotonically-decreasing function that also defines a helically-shaped material flow path configured to direct a weld material along the material flow path toward the distal end of the probe body at a controlled (e.g., constant) speed. Another aspect may provide for the helically-shaped material flow path being configured to direct a weld material along the flow path toward the distal end of the probe body at an increasing speed. Yet another aspect may provide the helically-shaped material flow path being configured to direct weld material along the flow path toward the distal end of the probe body at an intermediate speed as illustrated in FIG. 10B.

Some aspects of the present disclosure provide for helically-shaped flow paths of the weld material and/or workpiece material engaged by the outer probe surface, which are determined by defining the helical path(s) of geometric feature(s), such as screw threads, that are incorporated, engaged, and/or integrally formed with the outer surface of the probe body. The helical shape of the selected geometric feature(s) may be defined by the following vector equation, where r(t) represents the location of a particle of weld material in space as a function of time t, where: f(t), g(t), and h(t) are continuous functions representing the components of r(t) along the representative unit vectors i, j, and k.

r(t)=f(t)i+g(t)j+h(t)k EQ. 1

The velocity vector of a weld material traveling along a helical path defined by r(t) is obtained by differentiating EQ. 1, and is given by:

r′(t)=f′(t)i+g′(t)j+h′(t)k EQ. 2

The speed S(t) of a particle of weld material traveling along a helical path defined by r(t) is given by the magnitude of r′(t):

S(t)=|r′(t)|=\sqrt{[f′(t)]²+[g′(t)]²+[h′(t)]²} EQ. 3

The space vector r(t) in EQ. 1 may be represented by parametric equations as follows, where θ(t) represents the phase angle of the sine and cosine functions and r(t) represents the magnitude of the radius of the helically-shaped profile as a function of position along the z-axis, and where, for one aspect of the disclosure, z=t.

f(t)=x(t)=r(t)·cos [θ(t)] EQ. 4a

g(t)=y(t)=r(t)·sin [θ(t)] EQ. 4b

h(t)=z(t)=t EQ. 4c

Differentiating the parametric equations provides the following set of equations:

f′(t)=x′(t)=r′(t)·cos [θ(t)]−r(t)·sin [θ(t)]·θ′(t) EQ. 5a

g′(t)=y′(t)=r′(t)·sin [θ(t)]+r(t)·cos [θ(t)]·θ′(t) EQ. 5b

h′(t)=z′(t)=1 EQ. 5c

An equation for S(t) representing the speed of the weld material particle may subsequently be determined by incorporating EQS. 5a, 5b, and 5c with EQ. 3, which provides EQ. 6a, and is given by:

S(t)=\sqrt{[x′(t)]²+[y′(t)]²·[z′(t)]²} EQ. 6a

EQ. 6a defining S(t) may be written in terms of r(t), r′(t), and θ′(t), as previously defined in EQS. 5a, 5b, and 5c, so as to provide EQ. 6b:

S(t)=[r′(t)]²+[r(t)]²·[θ′(t)]²+1 EQ. 6b

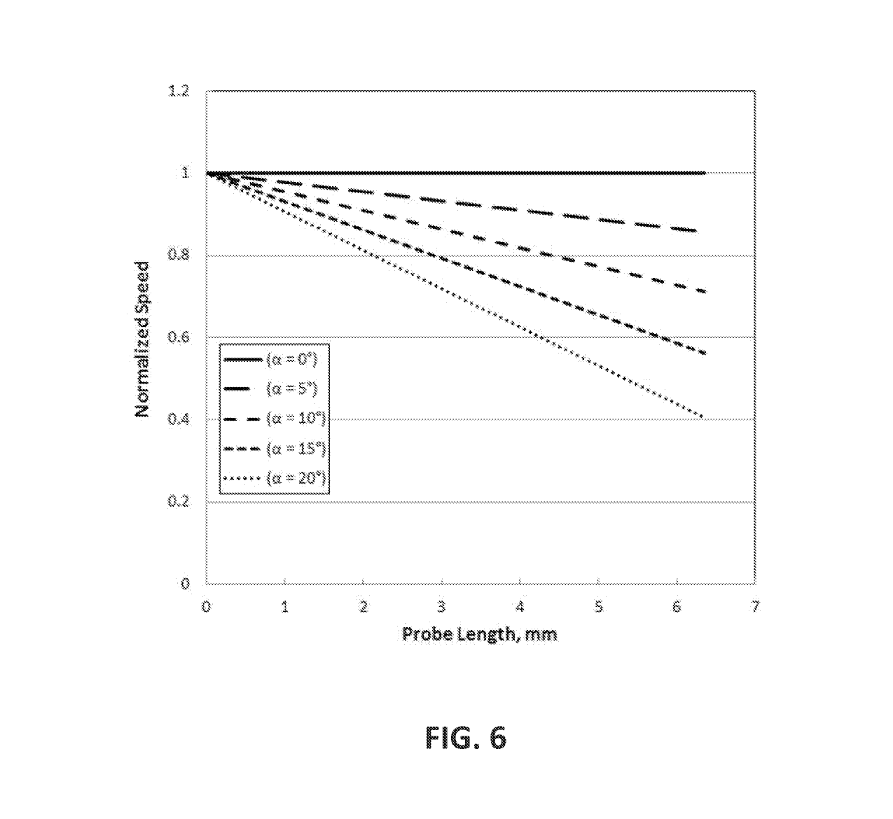

From EQ. 6b, the speed for a particle of weld material following the space curve defined by incorporating EQS. 4a, 4b, and 4c with EQ. 1 may be computed. For example, In FIG. 6, the normalized speed of a particle of weld material traveling along a helical path having a constant pitch as the particle of weld material travels toward the distal end of the probe body is plotted versus position along a length of probe body for linear frustum-shaped probe bodies having taper angles of approximately 0° (i.e., a cylindrical probe body), 5°, 10°, 15° and 20°, respectively. FIG. 6 illustrates that the speed of the weld material particle decreases significantly as the distance toward the distal end the weld material particle traverses increases and/or as the taper angle of the frustroconical-shaped probe increases.

Helical space curves configured to provide controlled speed functions S(t) along the length of a probe body in accordance with various aspects of the present disclosure may be determined by developing appropriate phase angle equations that produce the required results. For example, one aspect of the present disclosure may include helices configured to direct a weld material particle along the length of a helical flow path toward the distal end of the probe body defined by a non-linear, continuous, monotonically-decreasing function (e.g., profiles defined by ellipses, parabolas, and other functional forms) with a constant speed. A general equation for the phase angle θ(t) included in EQS. 4a and 4b and in EQS. 5a and 5b may be determined for any controlled, specified speed function S(t) by manipulating the terms in EQ. 6b and integrating so as to provide EQ. 7:

$$\int d θ ( t ) = \int \frac{\sqrt{{[ S ( t ) ]}^{2} - {[ {r}^{′} ( t ) ]}^{2} - 1}}{r ( t )} d t \qquad EQ . 7$$

In some aspects, when r and S both vary as functions of time, a solution for EQ. 7 may be determined utilizing standard numerical integration methods. According to another aspect, a solution for EQ. 7 may be determined analytically. For example, for a cylindrically-shaped probe body having a constant radius rₒ, a constant helical pitch, a function S(t) equal to a constant Sₒ, and a constant of integration c, EQ. 7 may be represented below as EQ. 8:

$$θ = \frac{{( {S}_{o}^{2} - 1 )}^{1 / 2}}{{r}_{o}} \cdot t + c \qquad EQ . 8$$

EQ. 8 may be manipulated to obtain relationships between S and the frequency f of the helix as follows:

S=[2πfrₒ]²+1 EQ. 9a

$$f = \frac{\sqrt{{S}^{2} - 1}}{2 π {r}_{o}} \qquad EQ . 9 b$$

In EQS. 9a and 9b, f represents the number of helical spirals per unit length (e.g., threads per inch), and 1/f represents the helical pitch (e.g., thread pitch). EQ. 9a may be used to determine the speed of a material particle as it moves along a helix for a cylindrical probe having a radius rₒ, as well as the starting or initial pitch for probes having a radius rₒ at their proximal ends and an axial profile defined by a non-linear, continuous, monotonically-decreasing function. While EQS. 4c through 9b describe particle motion along helical probe flow features for z=t, according to other aspects of this disclosure, particle motion may be described by other equations derived to describe, for example, the constant angular motion of a particle as it moves along a helix from the proximal to the distal end of a curved monotonically-decreasing probe profile.

Additionally, based on EQS. 6 and 7, a helical space curve may be determined for a probe body having a cylindrically-shaped profile that defines a material flow path configured to direct a weld material particle along the path toward the distal end with a decreasing speed substantially similar to the decreasing speed of a weld material particle traversing a material flow path defined by a frustoconically-shaped probe body. As S(t) varies as substantially linearly with respect to time in FIG. 6 for all taper angles, the equation at +b may be substituted into EQ. 7 for S(t) and integrated so as to provide EQ. 10, as provided below, which may be solved analytically and/or numerically:

$$θ ( t ) = \int \frac{\sqrt{{S ( t )}^{2} - 1}}{{r}_{o}} \cdot d t = \frac{1}{{r}_{o}} \int \sqrt{{( at + b )}^{2} - 1} \cdot d t \qquad EQ . 10$$

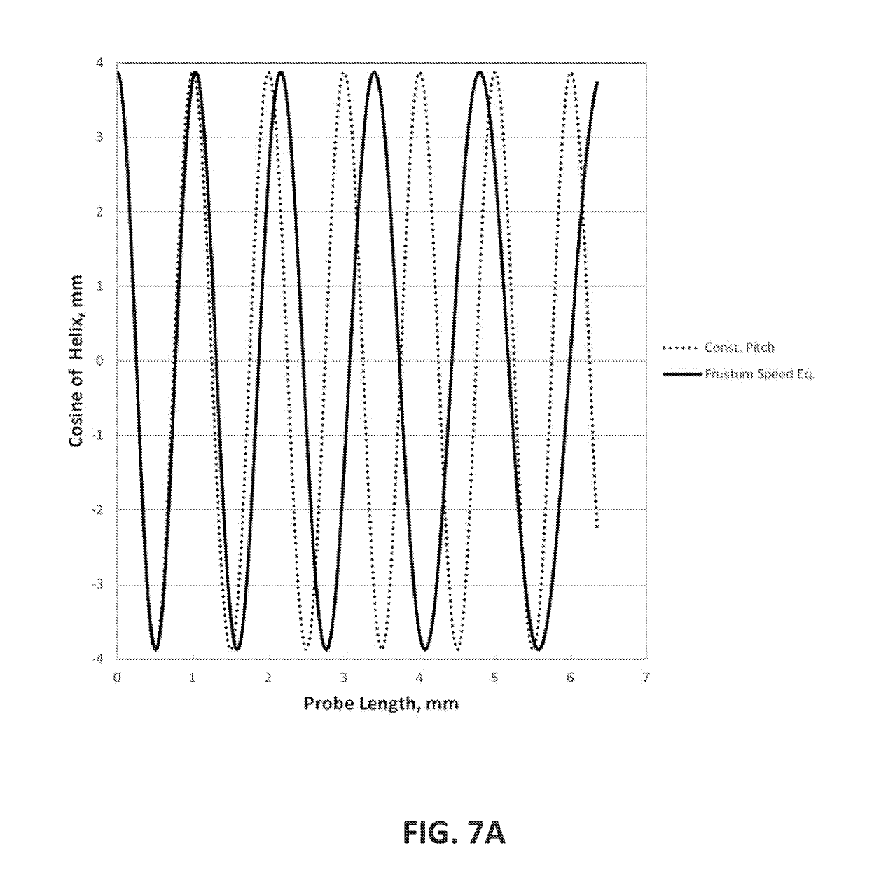

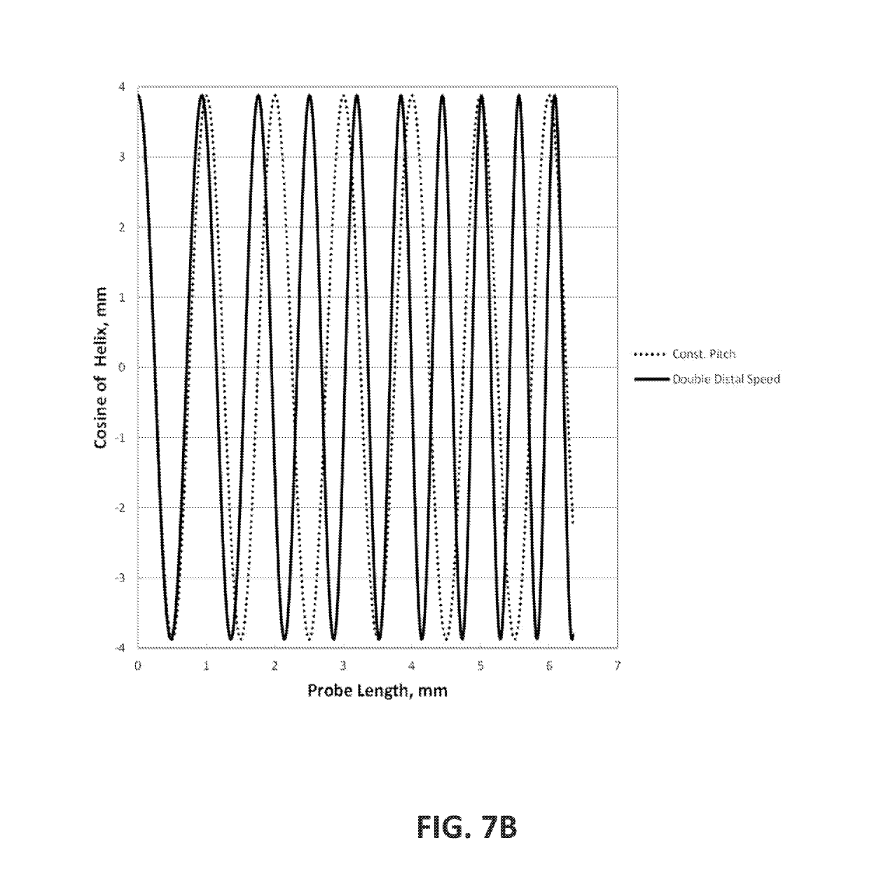

FIG. 7A presents the cosine components of space curves for a cylindrical probe body having a constant pitch helical space curve and a cylindrical probe body having a helical space curve configured to direct a particle along the flow path at speeds substantially equivalent to the speed distribution of a particle traversing along a constant pitch helical flow path defined by a frustoconically-shaped probe body. In particular, FIG. 7A illustrates a helically-shaped curve having an increasing pitch as the curve extends toward the distal end of the cylindrical probe body, which corresponds to the decreasing speed of the particle around and along the flow path defined by the outer surface of the cylindrical probe body. The decreasing speed of the particle corresponds to a decreasing speed experienced by the particle as it travels toward the distal end along a flow path defined by a frustoconically-shaped probe body defined by a radius that decreases toward the distal end of the probe body. In some aspects, the helical flow path of the cylindrical probe having an increasing pitch toward the distal end may affect the weld material and/or the workpiece material proximate the probe body in a similar manner to the weld material and/or workpiece material operably engaged by a frustoconically-shaped probe body having a helically-shaped material flow path, such as providing weld material having a lowered peak temperature proximate regions where the weld material travels the slowest along the helical flow path. In some aspects, a substantially cylindrical probe body may include a material flow path that directs the particle along the flow path with an increasing speed as the particle travels toward the distal end.

FIG. 7B presents the cosine component of a space curve for a cylindrically-shaped probe body configured such that the speed of a weld material particle disposed proximate the distal end is twice the speed of the weld material particle disposed near the proximal end of the probe body when traveling at a speed defined by EQ. 3 where z=t. The increase in speed is associated with a helical path with an increased length (FIG. 7B), corresponding to a longer material flow path. In particular, a pitch for such a helically-shaped flow path defined by a cylindrically-shaped probe body, which is configured to increase the speed of a weld material particle as the particle travels toward the distal end, decreases as the flow path extends toward the distal end of the cylindrically-shaped probe body.

EQ. 7 was formulated for the particular case in which an ideal particle of material follows a trajectory in space defined by a space curve such that it advances in time in a linear fashion along the z-axis. Other aspects include, for example, a flow path where the particle advances circumferentially at a constant rate along the space curve length as it advances toward the distal end of the probe.

Material flow paths based on curves defined by EQ. 7 or similarly formulated functions may be used to provide a measure of the relative speed between the tool surface that lies along a helical feature defined by EQ. 7 and the workpiece material (which the tool surface passes against). For slipping fiction conditions where the tool surface so defined by EQ. 7 passes over workpiece material that remains nominally in a given plane parallel to the tool axis, the relative speed between the two surfaces may be given as a function of position along the probe length by EQ. 7. For a sticking fiction condition, EQ. 7 may also provide an estimate of the relative speed across the shear boundary between workpiece material retained on the surface of the tool and adjacent workpiece material across the shear boundary. Therefore, EQ. 7 may provide a means to control the idealized relative speed along the probe length, such that the idealized relative speed between the tool and the workpiece along designed flow paths may be controlled to remain constant or to accelerate or decelerate according to a particular application requirement.

Weld material following a helical flow path along a frustroconically-shaped probe body may tend to stagnate or bunch up along the flow path as it approaches the distal end of the probe, thus tending to a less efficient flow behavior, particularly at the distal end of the probe. EQ. 7 may be used to define a helical flow path having an increasing length as it tends to the distal end of a monotonically-decreasing probe profile. The increasing line length may allow weld material to pass continuously from the proximal end of the probe to its distal end at a continuous rate until exiting at the distal end of the probe without significant stagnation along the flow path.

Aspects of the present disclosure may advantageously provide for more stable flow along a continuously-decreasing probe profile and thus provide a more uniform temperature distribution in regions of the workpiece disposed proximate the distal end of the probe body. The peak temperature in a friction stir welding process may increase as the rotational speed of the friction stir processing tool increases. Additionally, some aspects provide a flow path configured to increase the speed of the weld material particle by increasing the relative speed at the workpiece-tool interface along the helical space curve defined at least in part by surface features disposed on an outer surface of the probe body such that the temperature of the workpiece material, the weld material, and/or a region disposed proximate the distal end of the probe body also increases as the workpiece material and/or weld material traverses the helical space curve toward the distal end.

According to some aspects, a frustroconically-shaped probe body defining an axial profile having a material flow path provides another example where EQ. 7 may be determined analytically. The radius r(t) changes linearly along the length of a frustroconically-shaped profile, which greatly reduces the complexity of integrating EQ. 7. Defining r(t) as a linear function of time as r(t)=pt+rₒ, the first derivative of r(t) provides the constant p. In some aspects of the present disclosure where S is equal to a constant C, the numerator in EQ. 7 may be written as a single constant D, which may also be expressed as D=\sqrt{C²−p²−1}. Using E as the constant of integration and rₒ as the initial radius (i.e., the radius of the probe body near the proximal end), EQ. 6b can be solved to determine an exact solution of θ(t) as follows:

$$θ ( t ) = D \int \frac{1}{r} d t = D \int \frac{1}{pt - {r}_{o}} d t = \frac{D}{p} \cdot ln ( pt + {r}_{o} ) + E \qquad EQ . 11$$

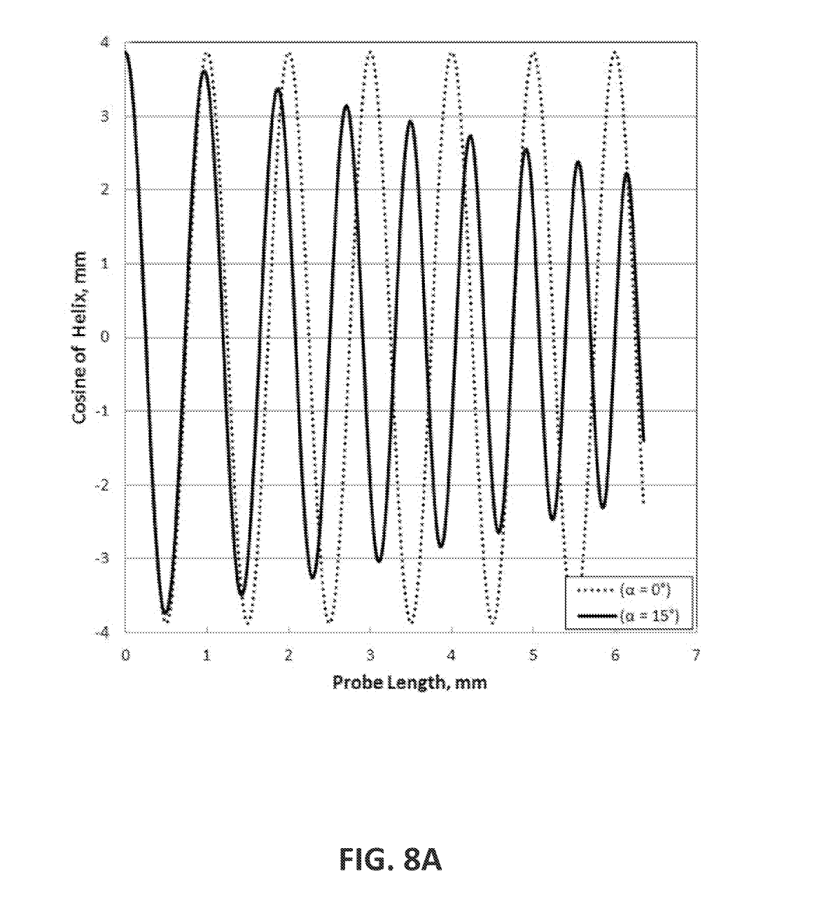

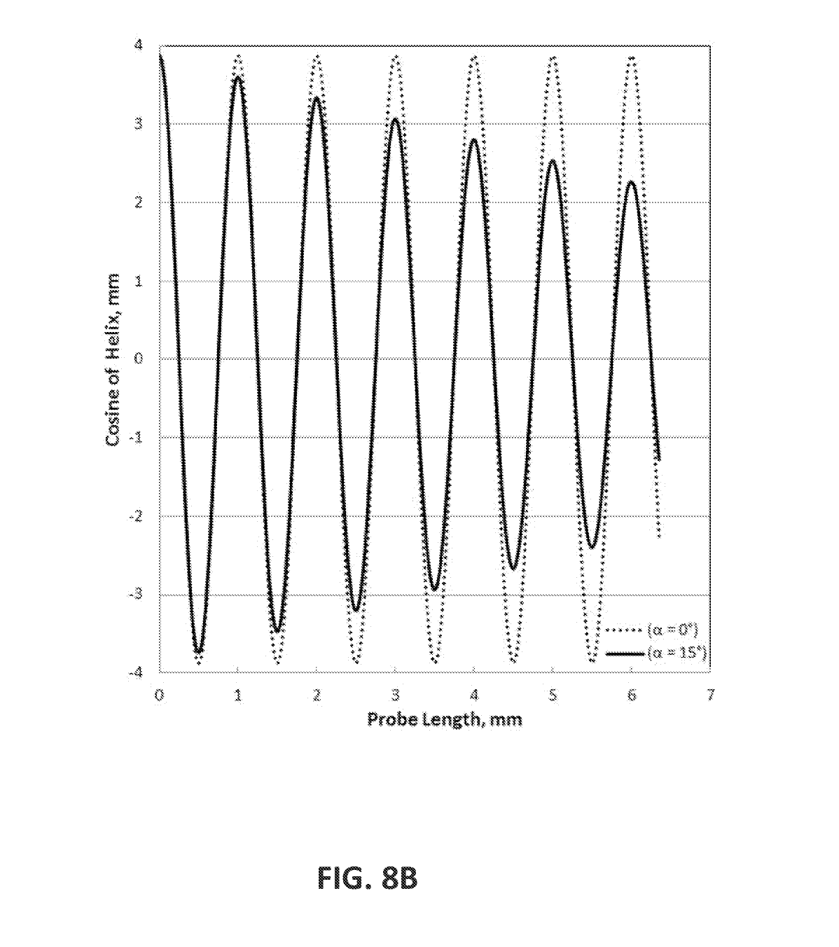

In this regard, EQ. 11 defines the phase angle θ(t) function for EQS. 4a, 4b, and 4c which generate a constant speed helically-shaped material flow path for frustoconically-shaped probe bodies. In this regard, FIGS. 8A and 8B illustrate the cosine curves (i.e., the x(t) component) of such helically-shaped material flow paths for frustoconically-shaped probe bodies. In addition, FIGS. 8A and 8B illustrate the cosine curve for substantially cylindrically-shaped probe bodies that define helically-shaped material flow paths for comparison. In contrast to the cosine curve for the constant pitch helically-shaped flow path defined by a frustoconically-shaped probe body, as illustrated in FIG. 8B, the cosine curve for the constant speed helically-shaped flow path, as shown in FIG. 8A, has a decreasing pitch as the distance from the proximal end increases and/or as the flow path travels toward the distal end. The cosine curve for the constant speed helically-shaped flow path defined by a frustoconically-shaped probe body, as shown in FIG. 8A, is illustrated to have a decreasing pitch along the length of the probe body such that the cosine curve for the constant pitch helically-shaped flow path defined by the frustoconically-shaped probe body, as illustrated in FIG. 8B, is out of phase with the cosine curves for the constant speed helically-shaped flow path of FIG. 8A. The decrease in the helical pitch, as shown in FIG. 8A, corresponds to the lateral cross-sectional dimension of the probe body as it decreases toward the distal end. Additionally, the length of the helically-shaped flow path necessarily increases so as to provide the controlled (e.g., constant) speed of the weld material particle as the weld material particle and/or a workpiece material is urged toward the distal end.

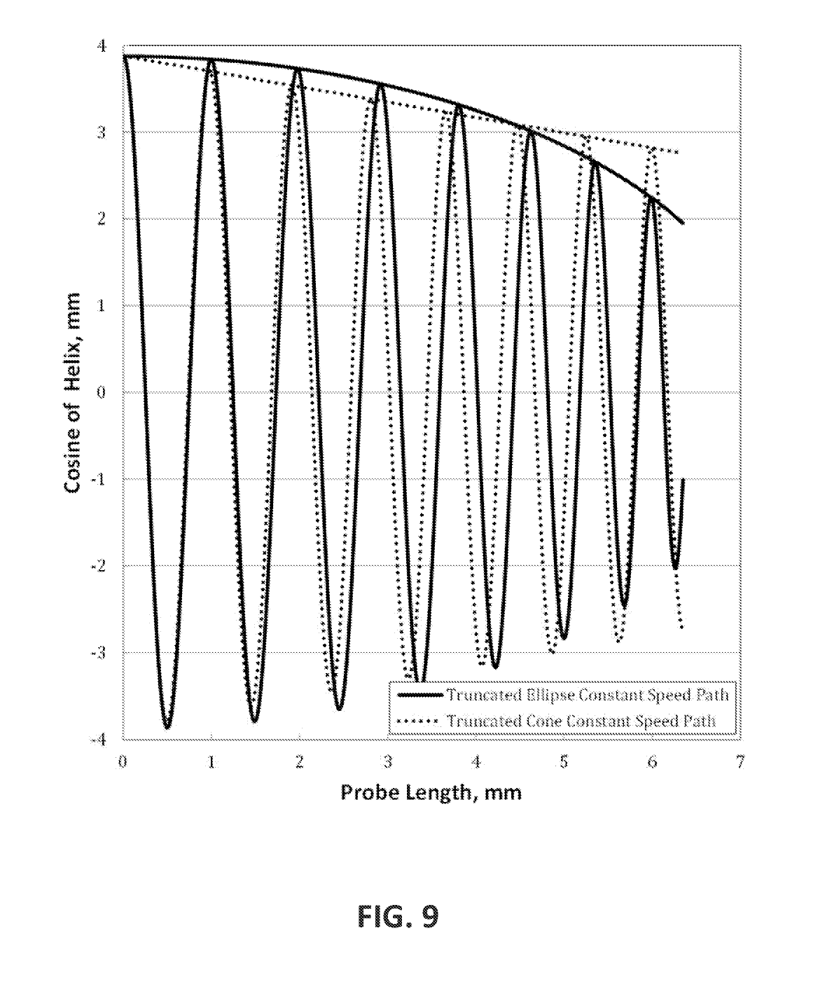

Although an analytical solution for a phase angle θ(t) function defined by EQ. 7 is not readily obtained for a friction stir processing tool that includes a probe body defined by a semi-elliptical shaped profile, similar to one illustrated in FIG. 4, numerical integration methods may provide for the integration of EQ. 7. Based on numerical analysis, FIG. 9 illustrates the cosine curve of a helically-shaped material flow path that directs a workpiece material and/or a weld material at a constant speed along the length of the flow path toward the distal end of the semi-elliptical shaped probe body illustrated in FIG. 4. Also illustrated in FIG. 9 is the cosine curve from FIG. 8A for the frustoconically-shaped probe body also provided in FIG. 4. Although the controlled (e.g., constant) speed cosine curves illustrated in FIG. 9 for the two probe bodies (e.g., truncated frustoconically-shaped probe body and truncated semi-elliptical shaped probe body) are similar in terms of helical pitch, aspects of the present disclosure provide a semi-elliptical shaped probe body that defines a helically-shaped flow path configured to direct the weld material along the flow path at a controlled (e.g., constant) speed toward the distal end and may further advantageously provide for increasing the direction of weld material flowing downwardly beyond the distal end of the friction stir processing tool, which may further advantageously concentrate and/or compact the workpiece material and/or flow of weld material such that the frequency of lack of penetration (LOP) flaws and/or voids are reduced.

According to one aspect of the present disclosure, FIG. 10A illustrates a probe body 10 having an axial profile portion 14 defined by a non-linear, continuous, monotonically-decreasing function. Additionally, the probe body 10 includes an outer surface 13 that defines a plurality of material flow paths 15 that are further defined by geometric surface features manufactured according to a method that may take the form of screw threads of various forms, and/or other geometric features such as helical grooves, ridges, flutes, and/or spiraled flats. In one aspect, as illustrated in FIG. 10, the probe body 10 may include a plurality of material flow paths 15 that may include threads defining crests having equal land widths. Additionally, according to one aspect, a friction stir processing tool that includes a probe body 10, as illustrated in FIG. 10, may include a material flow path 15 configured to direct a weld material particle along the flow path in accordance with an intermediate speed curve (i.e., the intermediate speed curve being bound between the speeds produced from a flow path having a constant pitch and the constant speeds produced by an exemplary flow path that has a decreasing pitch toward the distal end). In particular, FIG. 10B illustrates the intermediate speed curve of a weld material particle traveling along said intermediate helically-shaped curve, which is bound by a constant speed curve where the pitch of the helically-shaped material flow path decreases toward the distal end and by the decreasing speed curve produced by the constant pitch of the helically-shaped material flow path. With an intermediate speed curve, the crest width on the threads may be maintained at a constant, or decreasing, or increasing width as required by a given application.

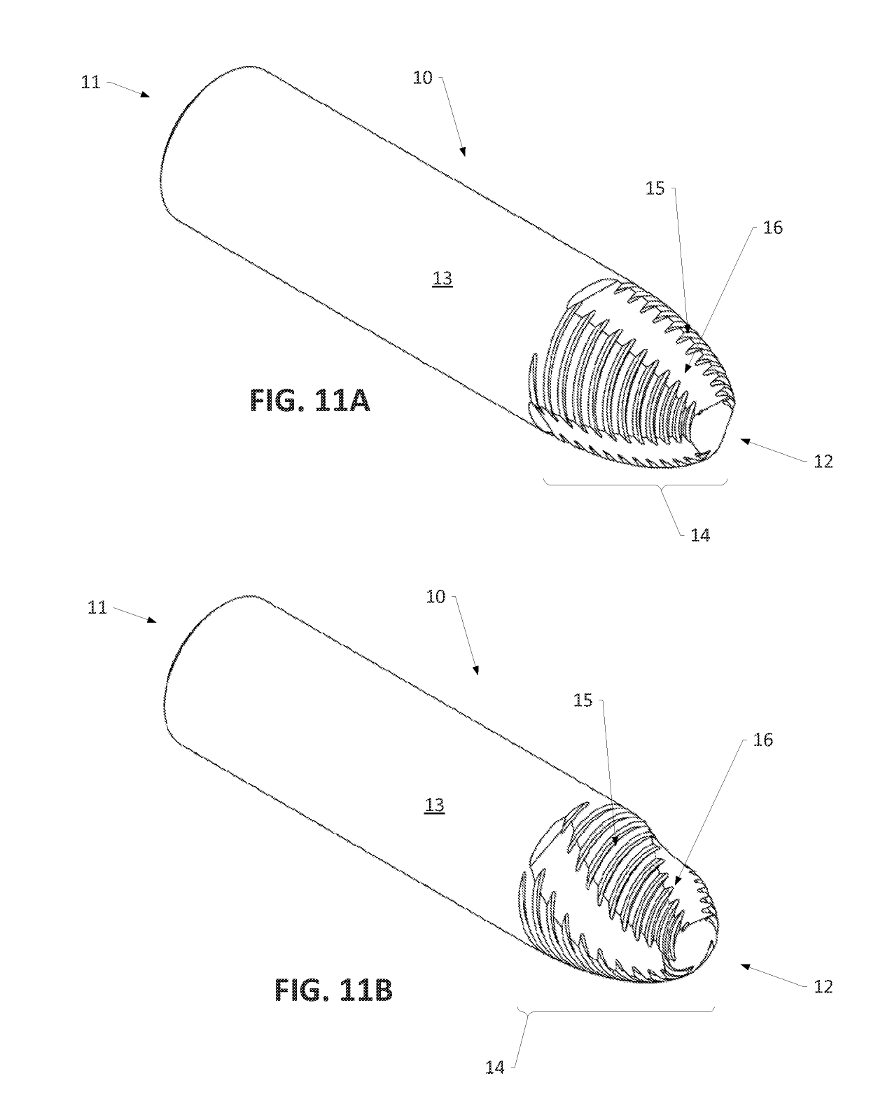

As shown in FIGS. 11A and 11B, some aspects of the present disclosure may provide a friction stir processing tool having a probe body 10 defined by a non-linear, continuous, monotonically-decreasing function, which further includes an outer surface 13 that defines a plurality of material flow paths 15, 16. According to one aspect, as shown in FIG. 11A, a friction stir processing tool may include a probe body 10 having a distal end 12 that defines at least one material flow path 15 having a substantially helical shape along the outer surface and further having a decreasing pitch as the flow path extends toward the distal end of the probe body. In some aspects, the probe body 10 may have a distal end 12 that further defines at least a second material flow path 16 that may be defined by geometric feature(s) such as a linear flat. According to another aspect, FIG. 11B illustrates a friction stir processing tool that includes a first material flow path 15 having a substantially helical shape along the outer surface and further having a decreasing pitch as the flow path extends toward the distal end of the probe body similar to the material flow path defined by probe body provided in FIG. 11A. Additionally, the friction stir processing tool may include a probe body 10 that defines an axial profile portion 14 disposed proximate the distal end 12 of the probe body, which defines at least a second material flow path 16 that may be defined by geometric feature(s) such as a helically-shaped flat. In another aspect, a probe body 10 may include a second material flow path defined by a geometric feature like a helically-shaped flat that has an opposing helical angle to the first material flow path 15. For example, as illustrated in FIG. 11B, the probe body 10 may define a first material flow path that is defined by right-hand threads, while the second material flow path is defined by left-hand helical flats.

Aspects of the present disclosure may provide a friction stir processing tool having a probe body 10 that includes a first material flow path 15 and a second material flow path 16. In some aspects, the first material flow path 15 may be configured to direct a weld material particle along the flow path toward the distal end at a first constant speed. According to another aspect, the second material flow path 16 may also be configured to direct a weld material particle along the second flow path toward the distal end at a second constant speed. In some embodiments, the first constant speed of the weld material traversing along the first material flow path may differ from the second constant speed of the weld material that traverses along the second material flow path. Additionally, some aspects may provide for a friction stir processing tool having a probe body 10 where the first material flow path 15 intersects with the second material flow path 16, as shown in both FIGS. 11A and 11B.

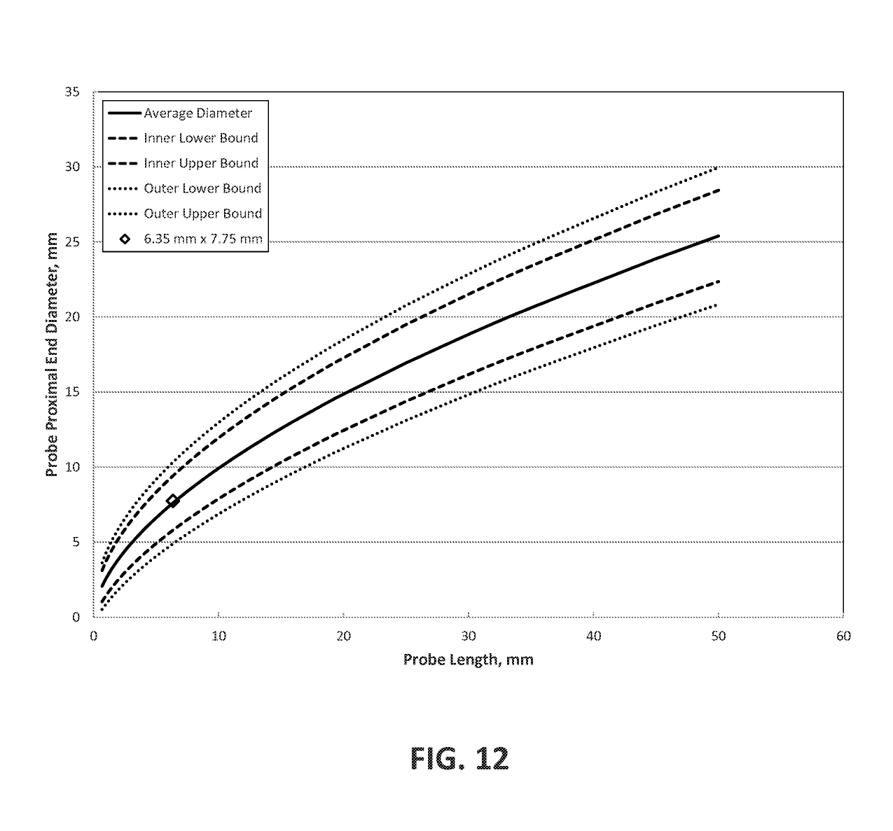

The differing size ranges for the exposed end of individual probe bodies (i.e., approximately the base and length of the curved axial profile portions 14) representative of the new controlled speed probe is illustrated in FIG. 12. The probe bodies illustrated in FIGS. 3, 10A, 11A and 11B measure approximately 6.35 mm in length and approximately 7.75 mm in diameter, and is further indicated by a diamond in FIG. 12. The curve marked Average Diameter in FIG. 12 is the diameter of the average exposed proximal end of a probe body 10 configured to operably engage a tool body 50. As illustrated in FIG. 9, for example, the diameter of the distal end of the probe body depends upon the elliptical shape selected for a given application and is generally between one third and two thirds of the proximal end diameter. The actual size of a given controlled speed probe body depends upon the application for which it is selected. Workpiece material and joint design can place certain restrictions upon the probe length-to-diameter ratio. For example, a tool narrower than the average diameter for a given probe length may be required to conform to a narrow joint design. Also, hard aerospace aluminum alloys, such as a 7000 series aluminum alloy like AA7075-T6, typically require tools having greater strength and thus require larger diameters than the Average Diameter shown in FIG. 12. Conversely, friction stir processing tool applications engineered for softer, more general purpose aluminum alloys such as AA6061 may include probe bodies that have smaller diameters because of the lower traversing forces present during the friction stir welding of these alloys. Joint fit-up gap requirements and tool alignment also factor into the selection of probe dimensions. Therefore, in addition to the Average Diameter of the proximal end of the probes illustrated in FIG. 12, inner and outer upper and inner and outer lower bounds are also illustrated in FIG. 12. The inner bounds represent 80% of the expected cases which will deviate from the Average Diameter curve. The outer bounding curves are inclusive of 95% of the cases which are expected to deviate from the Average Diameter curve.

Example aspects of the present disclosure may further include various geometric features such as thread forms that are operably engaged with, applied to, and/or integrally formed with the curved probe body that defines an axial profile, e.g., single- or multiple-lead ball screw threads. Example implementations of the present disclosure may retain the benefits of a flat-tipped friction stir processing tool similar to a frustroconically-shaped probe body, yet advantageously minimize the narrowing of the probe body over a substantial portion of its length while increasing the concentration of workpiece material and/or weld material disposed proximate the distal end of the probe.

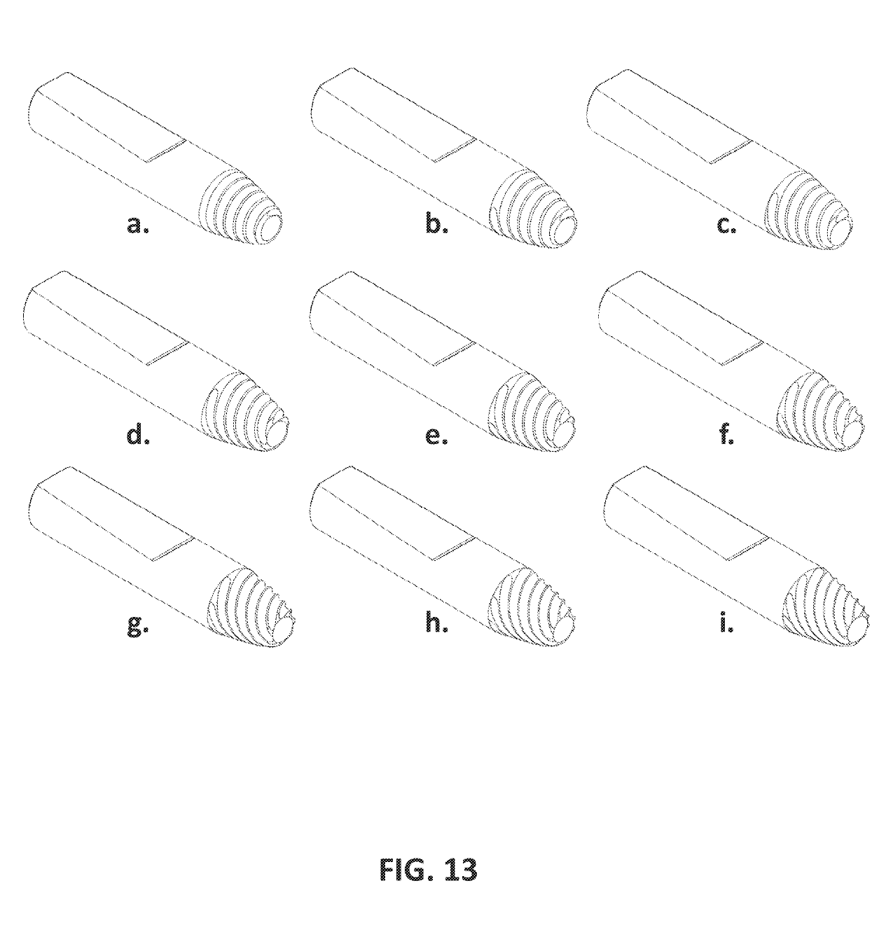

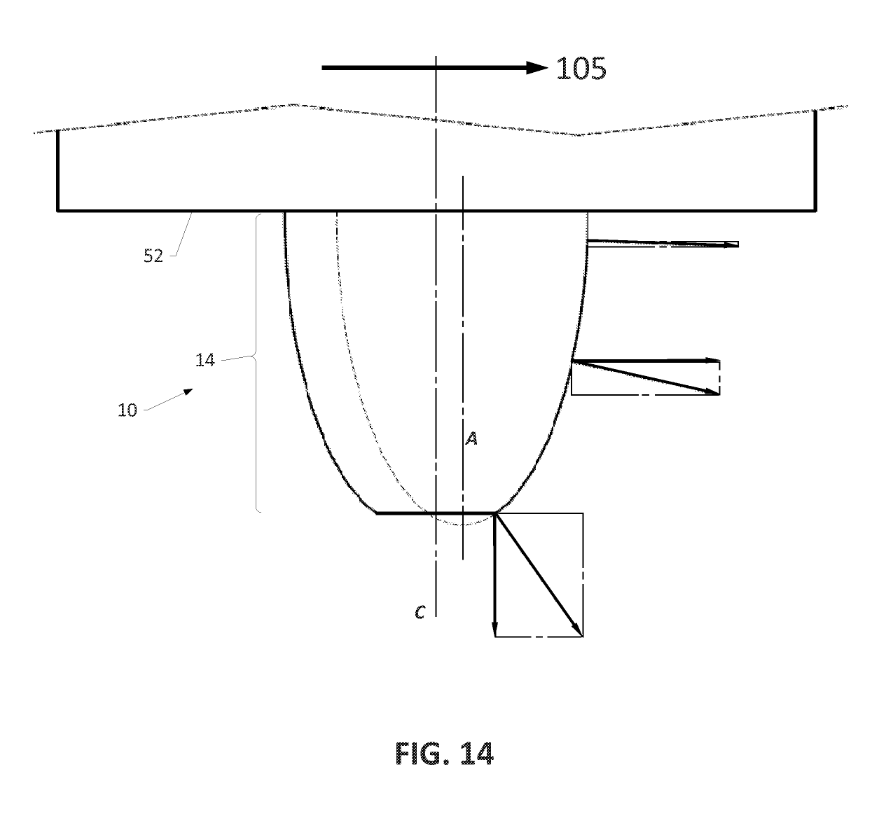

In some aspects, a friction stir processing tool may include a probe body having an axial profile portion based at least in part on an offset parabolic function and having a modified ball screw thread. Each of the probe bodies illustrated in FIG. 13 has a different number of thread starts: a) one, b) two, c) three, d) four, e) five, f) six, g) seven, h) eight, and i) nine.

According to another aspect, a friction stir processing tool may include a probe body having an axial profile portion based at least in part on an offset elliptical shape. As shown in FIG. 14, the major axis A that defines, in part, the elliptical shape of the axial profile portion of the probe body is disposed parallel to, but offset from, the centerline C of the friction stir processing tool.

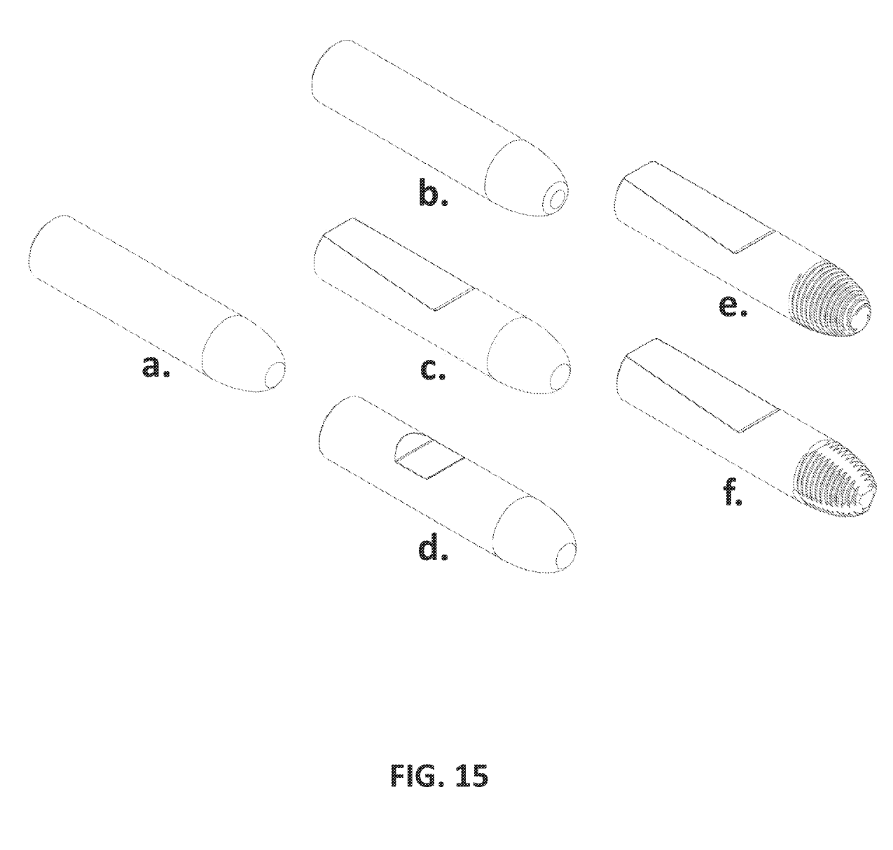

FIG. 15 illustrates: a) a featureless probe body blank ready for the application of tool features, with the potential inclusion of b) a fillet or chamfer on the distal end of the probe. Also, either c) an inclined flat clamping surface (WM), or d) a flat clamping section (WE) may be added to a probe shank of a multi-piece tool set for holding the probe in the tool body. Exemplary completed probe bodies may include e) a threaded portion of the exposed end of the probe body (i.e., a distal end of the probe body) and may optionally include 0 a set of flats.

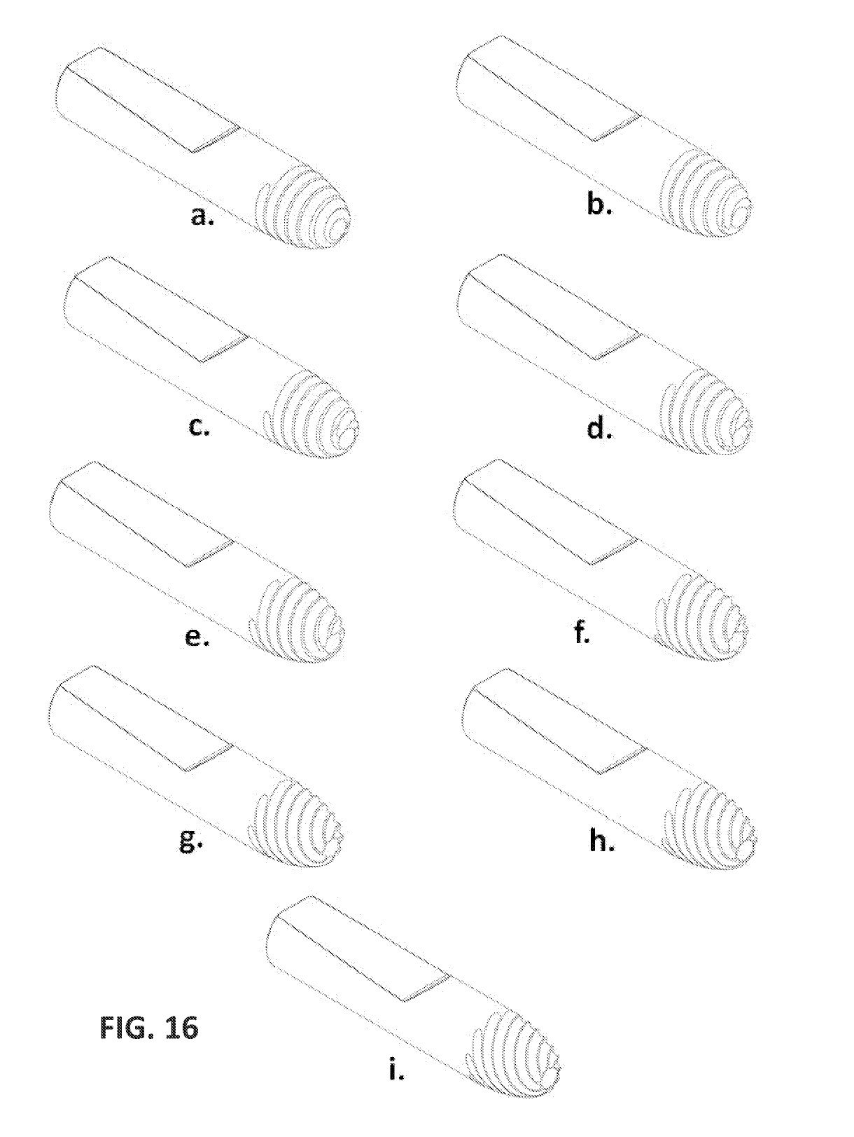

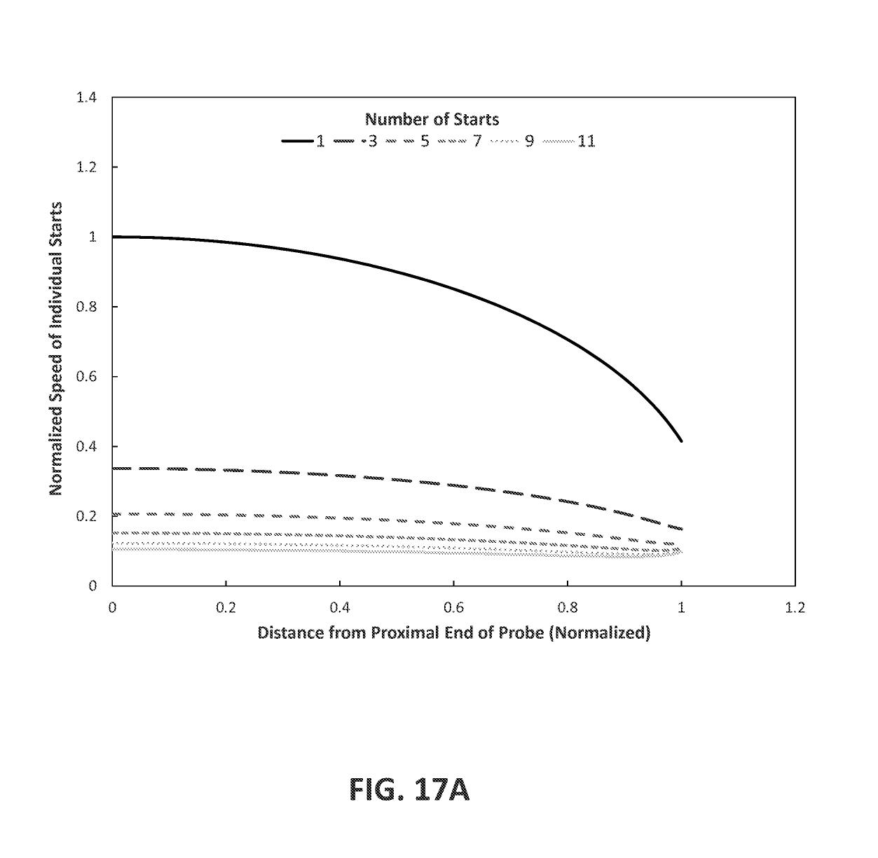

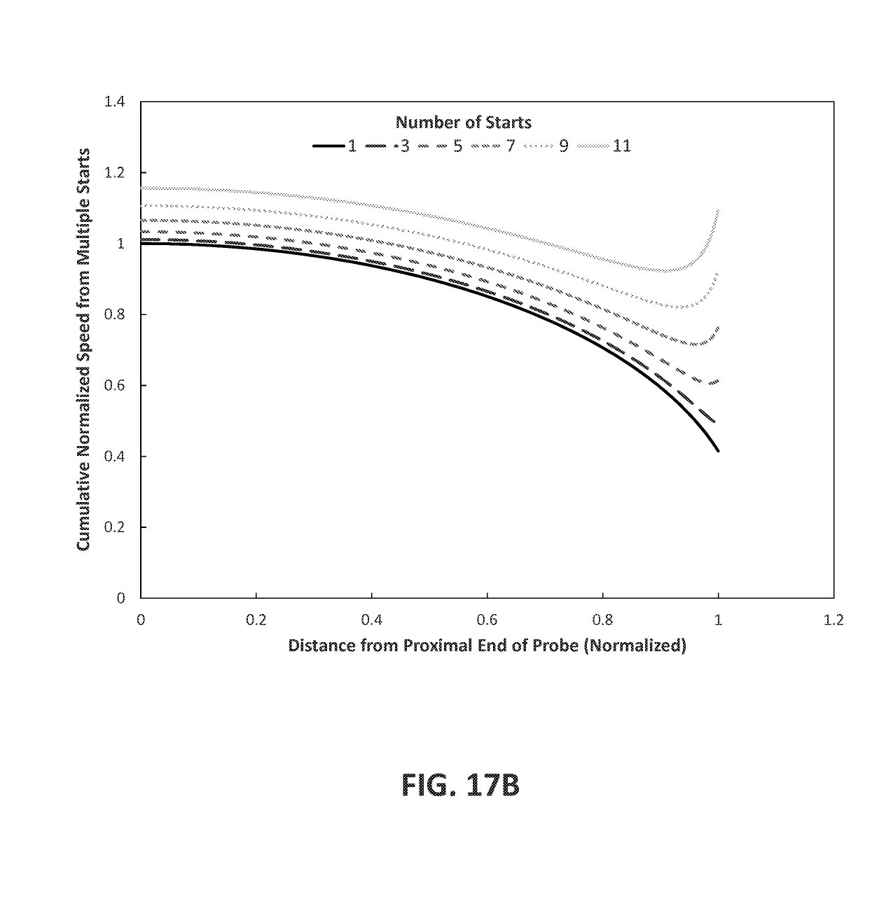

FIG. 16 illustrates a plurality of probe bodies based on an offset elliptical shape and having a modified helical ball screw thread. Each of the probes shown in FIG. 16 has a different number of flow paths defined by the thread starts. In particular, each of the probes illustrated in FIG. 16 has a different number of thread starts: a) one, b) two, c) three, d) four, e) five, f) six, g) seven, h) eight, and i) nine. As the number of thread starts increases, as illustrated in FIG. 16 for example, a greater amount of workpiece material and/or weld material may move from the proximal end of the probe body to the distal end along the flow path (i.e., the modified helical ball screw thread), and further, the amount of material directed toward the distal end increases substantially per turn. In this regard, FIGS. 17A and 17B illustrate the normalized speed of individual starts. In particular, FIG. 17A illustrates the normalized speed of a weld material traveling along each of the individual starts. As a weld material travels along a single thread, the weld material traverses a greater length from the proximal end to the distal end compared to a weld material following a single thread in a set of multiple thread starts. FIG. 17B, however, illustrates the cumulative normalized speed from multiple starts, and further illustrates that the cumulative effect of multiple threads acting in concert results in the weld material traveling at a greater average speed toward the distal end of the probe body. FIG. 17B further illustrates an upturn in cumulative speed of weld material proximate the distal end for the multi-start thread configurations illustrated. This acceleration in cumulative weld material movement as it approaches the distal end of the probe body may advantageously provide for compacting weld material both adjacent and beyond the distal end of the probe body. In addition, concentrating the flow of weld material as the weld material approaches the distal end of the probe body may further advantageously limit flaws during a friction stir process, and may further increase an operational envelope to open the process window to greater travel speeds and greater productivity.

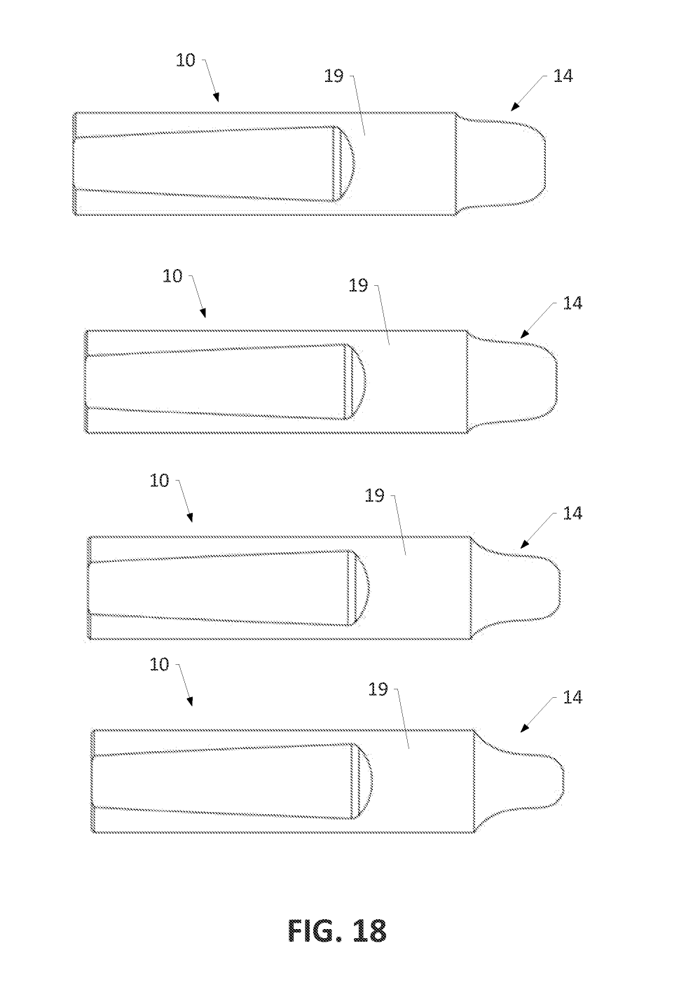

Another example aspect of this disclosure, as shown in FIG. 18, provides for probe bodies 10 having an axial probe profile 14 that is based on smooth polynomial functions (i.e., splines). Use of the splines to define an axial profile portion 14 allows probe bodies 10 to be made with a shank 19 having a common size with respect to one another, which advantageously provides for probe bodies that have differing axial profile portion diameters to be used interchangeably in a common tool body.

One aspect of the present disclosure provides a probe body 10 having an axial profile portion 14 that is based on a non-linear, continuous, monotonically-decreasing function. The outer surface 13 may define at least one material flow path 15 that is configured to direct a weld material toward the distal end of the probe body with a constant speed. In particular, the pitch of the helically-shaped material flow path 15 remains constant from the proximal end to the distal end, but the material flow path is configured to direct the weld material along the flow path with a constant speed by gradually decreasing the depth of the material flow path from the proximal end to the distal end. In particular, the graduated rise in the flow path from the proximal end to the distal end advantageously provides for constricting the flow path such that the weld material is urged to increase in speed as the weld material approaches the distal end of the probe body.

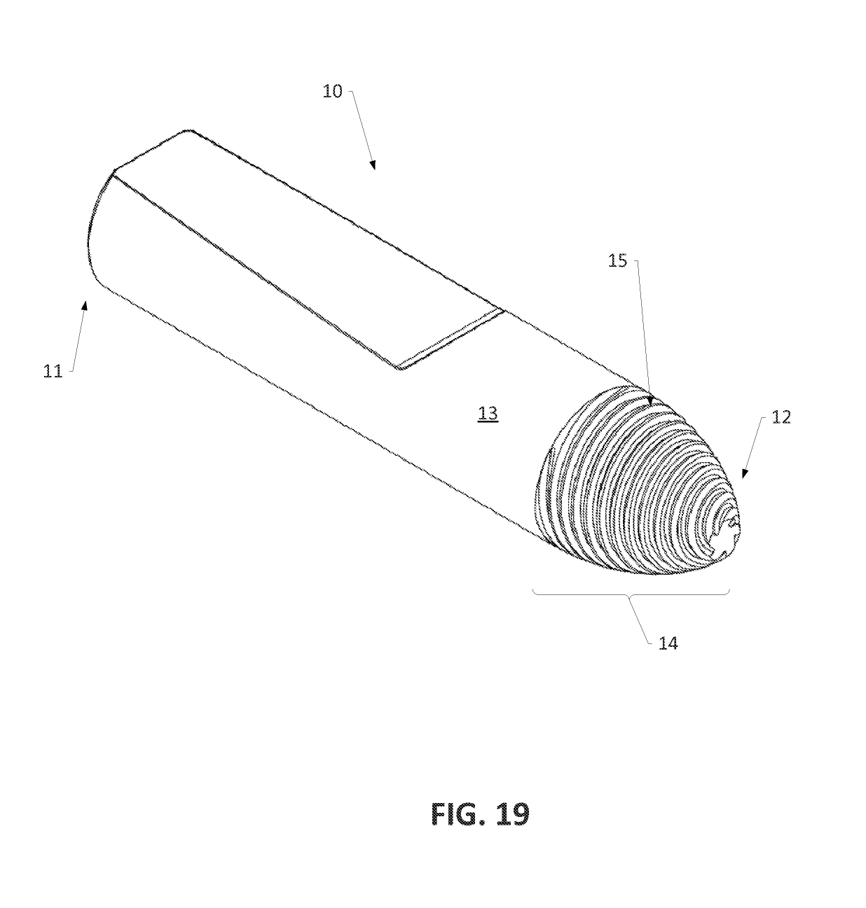

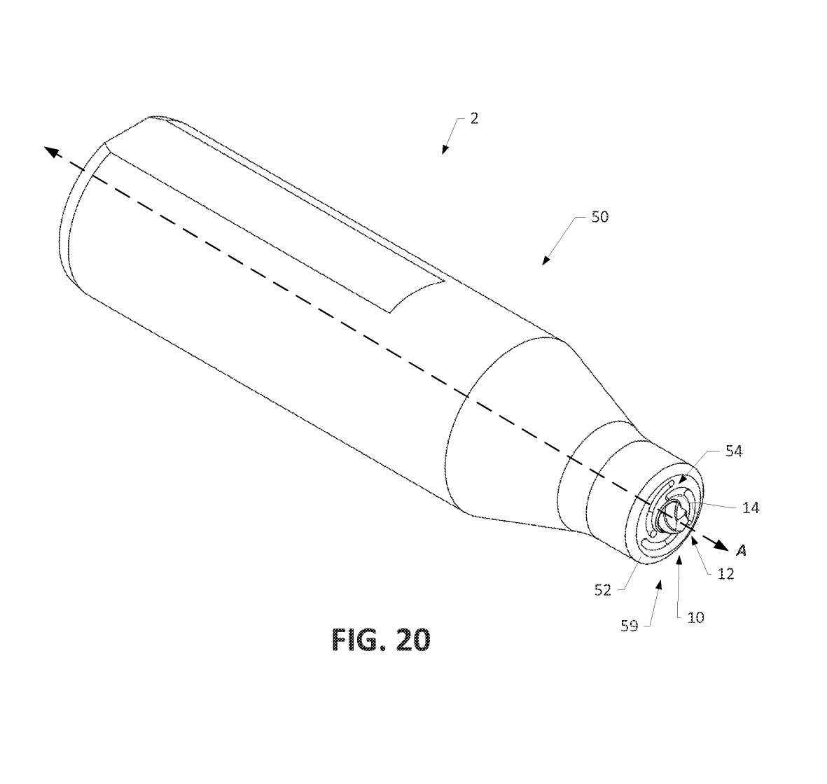

FIGS. 19 and 20 illustrate probe bodies 10 according to yet other aspects of the present disclosure. More particularly, FIG. 19 illustrates a probe body 10 for a friction stir processing tool configured to direct a weld material at a controlled (e.g., constant) speed along a material flow path that has a decreasing depth from the proximal end 11 to the distal end 12 of the probe body. FIG. 20 illustrates a probe body 10 (in a one-piece friction stir processing tool). In FIG. 20, the probe body has an elliptical profile and a set of five helical ridges separated by helical flats that are defined by controlled (e.g., constant) speed helical space curves.

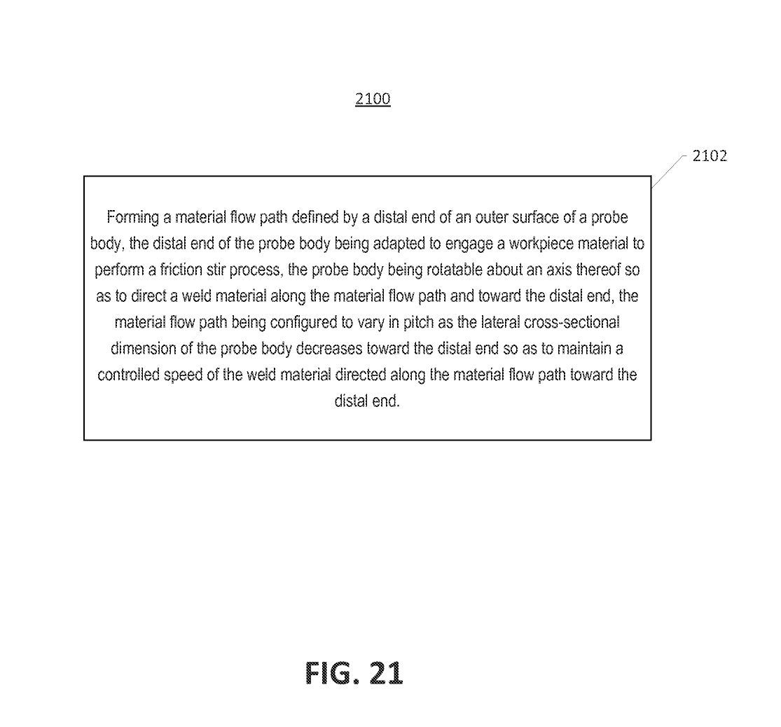

Aspects of the present disclosure may further provide a method 2100 for manufacturing a friction stir processing tool that includes a material flow path defined by a distal end of a probe body. As shown in FIG. 21, the method 2100 may include forming a material flow path defined by a distal end of an outer surface of a probe body (Block 2102). As mentioned previously, the distal end of the probe body may be adapted to operably engage a workpiece material to perform a friction stir process, such as friction stir welding and/or the like. The probe body may be rotatable about an axis thereof so as to direct a weld material, such as a portion of a workpiece material, along the material flow path and toward the distal end. In some aspects, the method may include forming a material flow path configured to vary (e.g., decrease) in pitch as the lateral cross-sectional dimension of the probe body decreases toward the distal end so as to maintain a constant speed of the weld material directed along the material flow path toward the distal end.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed herein and that modifications and other aspects are intended to be included within the scope of the appended claims. Although specific terms are employed herein, they are used in a generic and descriptive sense only and not for purposes of limitation.

That which is claimed:

1. A friction stir processing tool comprising:
a material flow path defined by a distal end of an outer surface of a probe body, the distal end of the probe body being adapted to engage a workpiece material to perform a friction stir process, the probe body being rotatable about an axis thereof so as to direct a weld material along the material flow path toward the distal end, the material flow path being configured to vary in pitch as the lateral cross-sectional dimension of the probe body decreases toward the distal end so as to maintain a controlled speed of the weld material directed along the material flow path toward the distal end.

2. The friction stir processing tool of claim 1, wherein the material flow path extends helically about the outer surface of the probe body.

3. The friction stir processing tool of claim 1, wherein the distal end of the outer surface of the probe body defines a plurality of material flow paths, each of the material flow paths being configured to vary in pitch as the lateral cross-sectional dimension of the probe body decreases toward the distal end so as to maintain a controlled speed of the weld material directed along each of the material flow paths toward the distal end.

4. The friction stir processing tool of claim 3, wherein the controlled speed of the weld material directed along one of the material flow paths is different from the controlled speed of the weld material directed along another of the material flow paths.

5. The friction stir processing tool of claim 3, wherein at least two of the material flow paths intersect.

6. The friction stir processing tool of claim 1, wherein a depth of the material flow path decreases toward the distal end.

7. The friction stir processing tool of claim 1, wherein the probe body defines an axial profile extending longitudinally toward the distal end, the axial profile being defined by a continuous, monotonically-decreasing function.

8. The friction stir processing tool of claim 7, wherein the continuous, monotonically-decreasing function is a non-linear, continuous, monotonically-decreasing function.

9. The friction stir processing tool of claim 8, wherein the axial profile of the probe body is parabolic.

10. The friction stir processing tool of claim 8, wherein the axial profile of the probe body is semi-elliptical.

11. A method of manufacturing a friction stir processing tool, the method comprising:
forming a material flow path defined by a distal end of an outer surface of a probe body, the distal end of the probe body being adapted to engage a workpiece material to perform a friction stir process, the probe body being rotatable about an axis thereof so as to direct a weld material along the material flow path and toward the distal end, the material flow path being configured to vary in pitch as the lateral cross-sectional dimension of the probe body decreases toward the distal end so as to maintain a controlled speed of the weld material directed along the material flow path toward the distal end.

12. The method of claim 11, wherein forming a material flow path further comprises forming a material flow path that extends helically about the outer surface of the probe body.

13. The method of claim 11, wherein forming a material flow path further comprises forming a plurality of material flow paths defined by the distal end of the outer surface of the probe body, each of the material flow paths being configured to vary in pitch as the lateral cross-sectional dimension of the probe body decreases toward the distal end so as to maintain a controlled speed of the weld material directed along each of the material flow paths toward the distal end.

14. The method of claim 13, wherein the controlled speed of the weld material directed along one of the material flow paths is different from the controlled speed of the weld material directed along another of the material flow paths.

15. The method of claim 13, wherein forming a plurality of material flow paths further comprises forming at least two material flow paths that intersect one another.

16. The method of claim 11, wherein forming a material flow path further comprises forming a material flow path having a depth that decreases toward the distal end.

17. The method of claim 11, wherein the probe body defines an axial profile extending longitudinally toward the distal end, the axial profile being defined by a continuous, monotonically-decreasing function.

18. The method of claim 17, wherein the continuous, monotonically-decreasing function is a non-linear, continuous, monotonically-decreasing function.

19. The method of claim 18, wherein the axial profile of the probe body is parabolic.

20. The method of claim 18, wherein the axial profile of the probe body is semi-elliptical.
